(19) United States
(12) Patent Application Publication
(10) Pub. No.: US 2026/0239441 A1
(43) Pub. Date: Aug. 13, 2026

(54) METHOD AND DEVICE FOR RANDOM ACCESS PROCEDURE IN WIRELESS COMMUNICATION SYSTEM

(71) Applicant: LG Electronics Inc., Seoul (KR)

(72) Inventors: Seokmin SHIN, Seoul (KR); Hyunsoo KO, Seoul (KR)

(21) Appl. No.: 19/156,563

(22) PCT Filed: Feb. 14, 2024
(86) PCT No.: PCT/KR2024/095144

§ 371 Date: Aug. 14, 2025

(30) Foreign Application Priority Data
Feb. 14, 2023 (KR) 10-2023-0019658
Feb. 27, 2023 (KR) 10-2023-0025599

(51) Int. Cl. H04W 74/0833

(52) U.S. Cl. CPC H04W 74/0833

(57) ABSTRACT

A method performed by a terminal according to an embodiment of the present disclosure comprises the steps of: selecting a set of random access resources on the basis of initiation of a random access procedure; transmitting MSG1; receiving a random access response (RAR); and transmitting MSG3.

### TECHNICAL FIELD

The present disclosure relates to a method and a device for a random access procedure in a wireless communication system.

### BACKGROUND

Mobile communication systems have been developed to guarantee user activity while providing voice services. Mobile communication systems are expanding their services from voice only to data. Current soaring data traffic is depleting resources and users' demand for higher-data rate services is leading to the need for more advanced mobile communication systems.

Next-generation mobile communication systems are required to meet, e.g., handling of explosively increasing data traffic, significant increase in per-user transmission rate, working with a great number of connecting devices, and support for very low end-to-end latency and high-energy efficiency. To that end, various research efforts are underway for various technologies, such as dual connectivity, massive multiple input multiple output (MIMO), in-band full duplex, non-orthogonal multiple access (NOMA), super wideband support, and device networking.

According to an Rel-17 feature combination, only one feature can be configured or a combination of a plurality of features can be configured in specific RACH resource partitioning. In Rel-18, a feature related to repetition of MSG1 is supported.

### DISCLOSURE

### Technical Problem

When an RSRP level of a specific terminal is low in a random access procedure, in general, MSG1 repetition and MSG3 repetition may be required at the same time. In addition to the above-described examples (MSG1 repetition and MSG3 repetition), there may be a feature(s) that needs to be applied/performed jointly in association with a specific feature. However, according to an existing scheme, one of the features that may be configured/included in a FeatureCombination parameter (FeatureCombination information element) is not defined to be associated with the other. In other words, only some of the features (e.g., MSG1 repetition and MSG3 repetition) that need to be applied in association with each other may be indicated by the FeatureCombination parameter. In this case, it may be inefficient in terms of indication of a feature(s) for the random access procedure.

In other words, the random access procedure performed based on the feature(s) indicated by the existing scheme is performed without applying the feature(s) associated with the indicated feature(s). That is, a reliability of the random access procedure may be reduced compared to a case in which all features that need to be applied jointly are indicated/applied. In addition, unnecessary signaling may be caused for further indication/application of the associated feature(s).

The present disclosure proposes a method for solving the problem described above.

The technical objects of the present disclosure are not limited to the aforementioned technical objects, and other technical objects, which are not mentioned above, will be apparently appreciated by a person having ordinary skill in the art from the following description.

### Technical Solution

A method performed by a user equipment (UE) in a wireless communication system according to an embodiment of the present disclosure includes: selecting a set of Random Access resources based on an initiation of a Random Access procedure based on initiation of a Random Access procedure; transmitting a Message 1 (MSG1); receiving a Random Access Response (RAR); and transmitting a Message 3 (MSG3).

Parameters for the Random Access procedure are initialized based on a configuration for the set of the Random Access resources. The parameters for the Random Access procedure include a FeatureCombination parameter.

The FeatureCombmination parameter may indicate one or more features. Based on the FeatureCombination parameter, a first feature and a second feature related to the first feature are jointly indicated.

The first feature includes a repetition of the MSG1, and the second feature includes a repetition of the MSG3.

The method may further include receiving System Information Block (SIB). A BWP-uplinkCommon parameter may be configured based on the SIB. A plurality of FeatureCombination parameters may be configured based on the BWP-uplinkCommon parameter.

The BWP-uplinkCommon parameter may include i) a rach-ConfigCommon parameter and ii) one or more AdditionalRACH-Config parameters.

The MSG1 may be transmitted based on one or more preambles. The one or more preambles may be determined based on a FeatureCombinationPreambles parameter.

The FeatureCombinationPreambles parameter may be configured based on i) one of the one or more AdditionalRACH-Config parameters or ii) the rach-ConfigCommon parameter.

The FeatureCombinationPreambles parameter may include the FeatureCombination parameter.

The one or more preambles may be based on consecutive preambles for the one or more features. A number of THE consecutive preambles may be 64.

One Synchronization Signal/Physical Broadcast CHannel Block (SSB) may be mapped to a Physical Random Access Channel (PRACH) Occasion related to the consecutive preambles.

The FeatureCombinationPreambles parameter may include information for a repetition number of the MSG1.

A specific AdditionalRACH-Config parameter among the one or more AdditionalRACH-Config parameters may be related to the first feature.

The FeatureCombinationPreambles parameter may be one of one or more FeatureCombinationPreambles parameters based on the specific AdditionalRACH-Config parameter.

The BWP-uplinkCommon parameter may include information representing an RSRP threshold related to the repetition of the MSG1.

A user equipment (UE) operating in a wireless communication system according to another embodiment of the present disclosure includes: one or more transceivers; one or more processors; and one or more memories connected to the one or more processors and storing instructions.

The instructions configure the one or more processors to perform all steps of a method of any one of claims 1 to 11 based on being executed by the one or more processors.

A device according to yet another embodiment of the present disclosure includes: one or more memories and one or more processors functionally connected to the one or more memories.

The one or more memories store instructions that configure the one or more processors to perform all steps of a method of any one among the methods based on being executed by the one or more processors.

One or more non-transitory computer-readable media according to still yet another embodiment of the present disclosure store instructions. The instructions executable by one or more processors configure the one or more processor to perform all steps of a method of any one among the methods.

A method performed by a base station in a wireless communication system according to still yet embodiment of the present disclosure includes: receiving a Message 1 (MSG1) based on an initiation of a Random Access procedure based on initiation of a Random Access procedure; transmitting a Random Access Response (RAR); and receiving a message 3 (MSG3).

Parameters for the Random Access procedure is initialized based on a configuration for a set of Random Access resources. The parameters for the Random Access procedure include a FeatureCombination parameter.

The FeatureCombmination parameter indicates one or more features. Based on the FeatureCombination parameter, a first feature and a second feature related to the first feature are jointly indicated.

The first feature includes a repetition of the MSG1, and the second feature includes a repetition of the MSG3.

A base station operating in a wireless communication system according to still yet another embodiment of the present disclosure includes: one or more transceivers; one or more processors; and one or more memories connected to the one or more processors and storing instructions.

The instructions configure the one or more processors to perform all steps of the method based on being executed by the one or more processors.

### Advantageous Effects

According to an embodiment of the present disclosure, a first feature and a second feature related to the first feature are jointly indicated.

Therefore, features that need to be simultaneously applied for effective execution of a random access procedure are jointly indicated, so that a reliability of the random access process can be ensured without limiting a flexibility of a base station configuration.

In addition, related features can be indicated at a time. It is possible to prevent further signaling for indication of remaining features (not indicated) from being caused due to indication of some of the related features.

An effect which can be obtained in the present disclosure are not limited to the aforementioned effect and other unmentioned advantages will be clearly understood by those skilled in the art from the following description.

### BRIEF DESCRIPTION OF THE DRAWINGS

FIG. 1 illustrates physical channels and general signal transmission used in a 3GPP system.

FIG. 2 illustrates RACH occasions for each preamble format.

FIG. 3 illustrates a random access procedure.

FIG. 4 illustrates an RACH partitioning related RRC parameter.

FIG. 5 is a flowchart for describing a method performed by a user equipment (UE) according to an embodiment of the present disclosure.

FIG. 6 is a flowchart for describing a method performed by a base station (BS) according to another embodiment of the present disclosure.

FIG. 7 is a diagram illustrating configurations of a first device and a second device according to an embodiment of the present disclosure.

### DETAILED DESCRIPTION

Hereinafter, preferred embodiments of the disclosure are described in detail with reference to the accompanying drawings. The following detailed description taken in conjunction with the accompanying drawings is intended for describing example embodiments of the disclosure, but not for representing a sole embodiment of the disclosure. The detailed description below includes specific details to convey a thorough understanding of the disclosure. However, it will be easily appreciated by one of ordinary skill in the art that embodiments of the disclosure may be practiced even without such details.

In some cases, to avoid ambiguity in concept, known structures or devices may be omitted or be shown in block diagrams while focusing on core features of each structure and device.

Hereinafter, downlink (DL) means communication from a base station to a terminal and uplink (UL) means communication from the terminal to the base station. In the downlink, a transmitter may be part of the base station, and a receiver may be part of the terminal. In the uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

### Physical Channel and General Signal Transmission

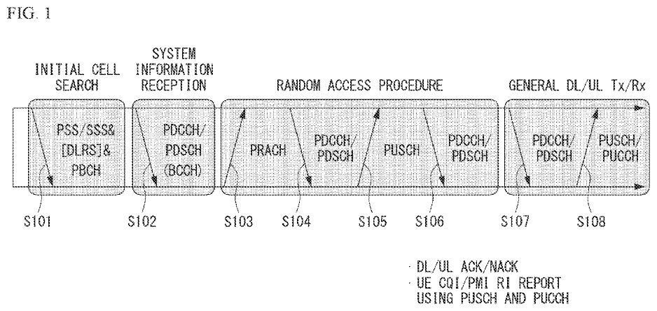

FIG. 1 illustrates physical channels and general signal transmission used in a 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S101). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. Meanwhile, the UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S102).

Meanwhile, when there is no radio resource first accessing the eNB or for signal transmission, the UE may perform a Random Access Procedure (RACH) to the eNB (S103 to S106). To this end, the UE may transmit a specific sequence to a preamble through a Physical Random Access Channel (PRACH) (S103 and S105) and receive a response message (Random Access Response (RAR) message) for the preamble through the PDCCH and a corresponding PDSCH. In the case of a contention based RACH, a Contention Resolution Procedure may be additionally performed (S106).

The UE that performs the above procedure may then perform PDCCH/PDSCH reception (S107) and Physical Uplink Shared Channel (PUSCH)/Physical Uplink Control Channel (PUCCH) transmission (S108) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

Meanwhile, the control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., through the PUSCH and/or PUCCH.

An RACH slot is described below.

An RACH slot includes one or multiple RACH Occasion(s).

Slot duration is 1 ms for {1.25 kHz, 5 kHz} subcarrier spacing, and has scalable duration (i.e., 1 ms, 0.5 ms, 0.25 ms, 0.125 ms) for {15 kHz, 30 kHz, 60 kHz, 120 kHz} subcarrier spacing.

A start OFDM symbol index in an RACH slot has {0,2,x} values for short preamble formats.

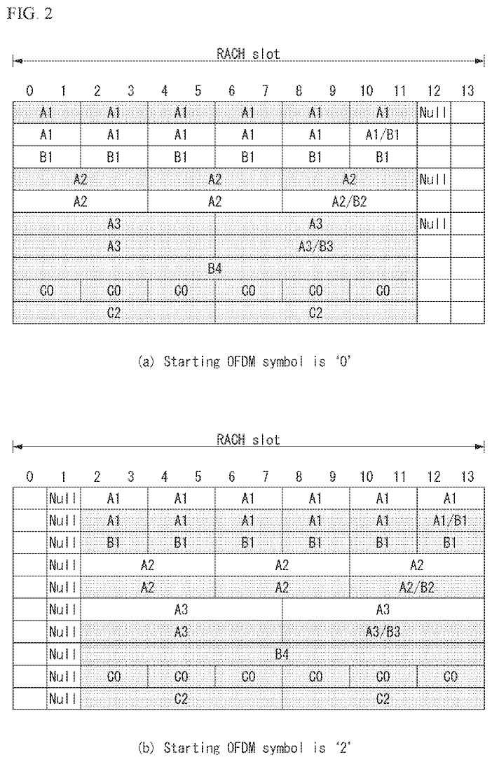

FIG. 2 illustrates RACH occasions for each preamble format.

Referring to FIG. 2, an RACH slot may include one or more RACH occasions (ROs) for each preamble format (e.g., A1, A2, . . . . C2). (a) of FIG. 2 illustrates a case in which a starting OFDM symbol is ‘0’, and (b) of FIG. 2 illustrates a case in which a starting OFDM symbol is ‘2’.

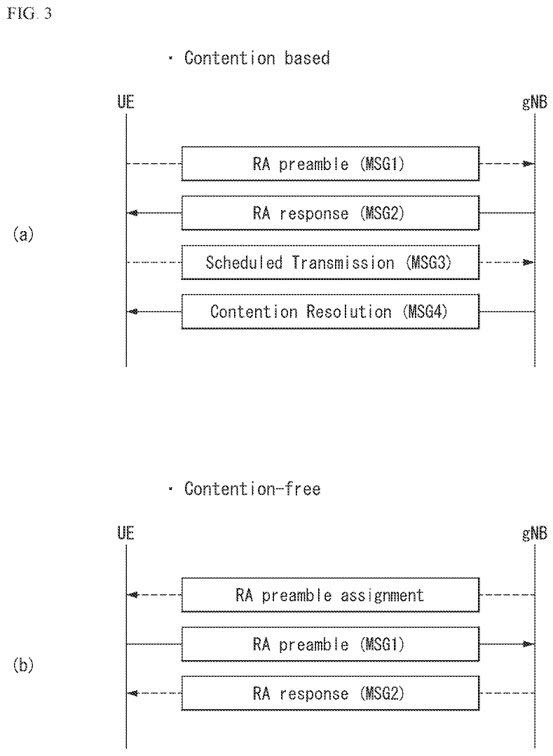

FIG. 3 illustrates a random access procedure.

(a) of FIG. 3 illustrates a contention based RACH procedure, and (b) of FIG. 3 illustrates a contention free RACH procedure.

MSG1 transmission is described below.

Subcarrier spacing for MSG1 is configured in an RACH configuration, and is provided in a handover command with respect to a contention-free RA procedure for handover.

Preamble indices for contention-based random access (CBRA) and contention-free random access (CFRA) are consecutively mapped to one SSB in one RACH transmission occasion.
CBRA: Association between an SS block (SSB) within an SS burst set and a subset of RACH resources and/or preamble indices is configured by a parameter set in an RMSI.
CFRA: A UE may be configured transmit multi-MSGIs through a dedicated multi-RACH transmission occasion in the time domain before the end of a monitored RAR window.

Furthermore, association between a CFRA preamble and an SSB is reconfigured through UE-specific RRC.

The random access procedure may be a Type-1 random access procedure (4-step RA) or a Type-2 random access procedure (2-step RA).

The Type-1 random access procedure may include transmission of random access preamble in a physical random access channel (PRACH) (Msg1), reception of a random access response (RAR) (Msg2), transmission of PUSCH scheduled by UL grant of the RAR (Msg3), and PDSCH for contention resolution (Msg4). If the random access procedure is contention free random access (CFRA), the Msg3 transmission and the Msg4 reception are omitted.

The Type-2 random access procedure may include transmission of random access preamble and PUSCH (MsgA) and RAR reception (MsgB).

The following Table 1 shows configurations/operations related to the random access preamble.

The configurations/definitions/operations according to Table 1 above may be referred to in order to clarify definitions/operations of embodiments to be described below. As an example, in an embodiment to be described below, ROs may refer to the valid PRACH occasions mentioned in Table 1. As an example, in an embodiment to be described below, multiple ROs having a same beam index may mean 1/N (where, N<1) consecutive valid PRACH occasions to which one SS/PBCH index is mapped.

Tables 2 to 4 below illustrate PRACH configuration tables to which the embodiments to be described below may be applied.

TABLE 2
Table 6.3.3.2-2: Random access configurations for FRI and paired spectrum/supplementary uplink.

| | | | | | | | ${N}_{number}^{RA , slot} , of$ | |
|---|---|---|---|---|---|---|---|---|
| | | | | | | | time-domain | |
| | | | | | | Number of | PRACH | |
| PRACH | | | | | | PRACH | ccasions | ${N}_{dur}^{RA} ,$ |
| Configuration | Preamble | n_{SFN}modx = y | | Subframe | Starting | slots within a | within a | PRACH |
| index | format | x | y | number | symbol | subframe | PRACH slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| 11 | 0 | 4 | 1 | 9 | 0 | — | — | 0 |
| 12 | 0 | 2 | 1 | 1 | 0 | — | — | 0 |
| 13 | 0 | 2 | 1 | 4 | 0 | — | — | 0 |
| 14 | 0 | 2 | 1 | 7 | 0 | — | — | 0 |
| 15 | 0 | 2 | 1 | 9 | 0 | — | — | 0 |
| 16 | 0 | 1 | 0 | 1 | 0 | — | — | 0 |
| 17 | 0 | 1 | 0 | 4 | 0 | — | — | 0 |
| 18 | 0 | 1 | 0 | 7 | 0 | — | — | 0 |
| 19 | 0 | 1 | 0 | 1, 6 | 0 | — | — | 0 |
| 20 | 0 | 1 | 0 | 2, 7 | 0 | — | — | 0 |
| 21 | 0 | 1 | 0 | 3, 8 | 0 | — | — | 0 |
| 22 | 0 | 1 | 0 | 1, 4, 7 | 0 | — | — | 0 |
| 23 | 0 | 1 | 0 | 2, 5, 8 | 0 | — | — | 0 |
| 24 | 0 | 1 | 0 | 3, 6, 9 | 0 | — | — | 0 |
| 25 | 0 | 1 | 0 | 0, 2, 4, 6, 8 | 0 | — | — | 0 |
| 26 | 0 | 1 | 0 | 1, 3, 5, 7, 9 | 0 | — | — | 0 |
| 27 | 0 | 1 | 0 | 0, 1, 2, 3, 4, | 0 | — | — | 0 |
| | | | | 5, 6, 7, 8, 9 | | | | 0 |
| 28 | 1 | 16 | 1 | 1 | 0 | — | — | 0 |
| 29 | 1 | 16 | 1 | 4 | 0 | — | — | 0 |
| 30 | 1 | 16 | 1 | 7 | 0 | — | — | 0 |
| 31 | 1 | 16 | 1 | 9 | 0 | — | — | 0 |
| 32 | 1 | 8 | 1 | 1 | 0 | — | — | 0 |
| 33 | 1 | 8 | 1 | 4 | 0 | — | — | 0 |
| 34 | 1 | 8 | 1 | 7 | 0 | — | — | 0 |
| 35 | 1 | 8 | 1 | 9 | 0 | — | — | 0 |
| 36 | 1 | 4 | 1 | 1 | 0 | — | — | 0 |
| 37 | 1 | 4 | 1 | 4 | 0 | — | — | 0 |
| 38 | 1 | 4 | 1 | 7 | 0 | — | — | 0 |
| 39 | 1 | 4 | 1 | 9 | 0 | — | — | 0 |
| 40 | 1 | 2 | 1 | 1 | 0 | — | — | 0 |
| 41 | 1 | 2 | 1 | 4 | 0 | — | — | 0 |
| 42 | 1 | 2 | 1 | 7 | 0 | — | — | 0 |
| 43 | 1 | 2 | 1 | 9 | 0 | — | — | 0 |
| 44 | 1 | 1 | 0 | 1 | 0 | — | — | 0 |
| 45 | 1 | 1 | 0 | 4 | 0 | — | — | 0 |
| 46 | 1 | 1 | 0 | 7 | 0 | — | — | 0 |
| 47 | 1 | 1 | 0 | 1, 6 | 0 | — | — | 0 |
| 48 | 1 | 1 | 0 | 2, 7 | 0 | — | — | 0 |
| 49 | 1 | 1 | 0 | 3, 8 | 0 | — | — | 0 |
| 50 | 1 | 1 | 0 | 1, 4, 7 | 0 | — | — | 0 |
| 51 | 1 | 1 | 0 | 2, 5, 8 | 0 | — | — | 0 |
| 52 | 1 | 1 | 0 | 3, 6, 9 | 0 | — | — | 0 |
| 53 | 2 | 16 | 1 | 1 | 0 | — | — | 0 |
| 54 | 2 | 8 | 1 | 1 | 0 | — | — | 0 |
| 55 | 2 | 4 | 0 | 1 | 0 | — | — | 0 |
| 56 | 2 | 2 | 0 | 1 | 0 | — | — | 0 |
| 57 | 2 | 2 | 0 | 5 | 0 | — | — | 0 |
| 58 | 2 | 1 | 0 | 1 | 0 | — | — | 0 |
| 59 | 2 | 1 | 0 | 5 | 0 | — | — | 0 |
| 60 | 3 | 16 | 1 | 1 | 0 | — | — | 0 |
| 61 | 3 | 16 | 1 | 4 | 0 | — | — | 0 |
| 62 | 3 | 16 | 1 | 7 | 0 | — | — | 0 |
| 63 | 3 | 16 | 1 | 9 | 0 | — | — | 0 |
| 64 | 3 | 8 | 1 | 1 | 0 | — | — | 0 |
| 65 | 3 | 8 | 1 | 4 | 0 | — | — | 0 |
| 66 | 3 | 8 | 1 | 7 | 0 | — | — | 0 |
| 67 | 3 | 4 | 1 | 1 | 0 | — | — | 0 |
| 68 | 3 | 4 | 1 | 4 | 0 | — | — | 0 |
| 69 | 3 | 4 | 1 | 7 | 0 | — | — | 0 |
| 70 | 3 | 4 | 1 | 9 | 0 | — | — | 0 |
| 71 | 3 | 2 | 1 | 1 | 0 | — | — | 0 |
| 72 | 3 | 2 | 1 | 4 | 0 | — | — | 0 |
| 73 | 3 | 2 | 1 | 7 | 0 | — | — | 0 |
| 74 | 3 | 2 | 1 | 9 | 0 | — | — | 0 |
| 75 | 3 | 1 | 0 | 1 | 0 | — | — | 0 |
| 76 | 3 | 1 | 0 | 4 | 0 | — | — | 0 |
| 77 | 3 | 1 | 0 | 7 | 0 | — | — | 0 |
| 78 | 3 | 1 | 0 | 1, 6 | 0 | — | — | 0 |
| 79 | 3 | 1 | 0 | 2, 7 | 0 | — | — | 0 |
| 80 | 3 | 1 | 0 | 3, 8 | 0 | — | — | 0 |
| 81 | 3 | 1 | 0 | 1, 4, 7 | 0 | — | — | 0 |
| 82 | 3 | 1 | 0 | 2,5,8 | 0 | — | — | 0 |
| 83 | 3 | 1 | 1 | 3, 6, 9 | 0 | — | — | 0 |
| 84 | 3 | 1 | 0 | 0, 2, 4, 6, 8 | 0 | — | — | 0 |
| 85 | 3 | 1 | 0 | 1, 3, 5, 7, 9 | 0 | — | — | 0 |
| 86 | 3 | 1 | 0 | 0, 1, 2, 3, 4, | 0 | — | — | 0 |
| | | | | 5, 6, 7, 8, 9 | | | | |
| 87 | A1 | 16 | 0 | 4, 9 | 0 | 1 | 6 | 2 |
| 88 | A1 | 16 | 1 | 4 | 0 | 2 | 6 | 2 |
| 89 | A1 | 8 | 0 | 4, 9 | 0 | 1 | 6 | 2 |
| 90 | A1 | 8 | 1 | 4 | 0 | 2 | 6 | 2 |
| 91 | A1 | 4 | 0 | 4, 9 | 0 | 1 | 6 | 2 |
| 92 | A1 | 4 | 1 | 4, 9 | 0 | 1 | 6 | 2 |
| 93 | A1 | 4 | 0 | 4 | 0 | 2 | 6 | 2 |
| 94 | A1 | 2 | 0 | 4, 9 | 0 | 1 | 6 | 2 |
| 95 | A1 | 2 | 0 | 1 | 0 | 2 | 6 | 2 |
| 96 | A1 | 2 | 0 | 4 | 0 | 2 | 6 | 2 |
| 97 | A1 | 2 | 0 | 7 | 0 | 2 | 6 | 2 |
| 98 | A1 | 1 | 0 | 4 | 0 | 1 | 6 | 2 |
| 99 | A1 | 1 | 0 | 1, 6 | 0 | 1 | 6 | 2 |
| 100 | A1 | 1 | 0 | 4, 9 | 0 | 1 | 6 | 2 |
| 101 | A1 | 1 | 0 | 1 | 0 | 2 | 6 | 2 |
| 102 | A1 | 1 | 0 | 7 | 0 | 2 | 6 | 2 |
| 103 | A1 | 1 | 0 | 2, 7 | 0 | 2 | 6 | 2 |
| 104 | A1 | 1 | 0 | 1, 4, 7 | 0 | 2 | 6 | 2 |
| 105 | A1 | 1 | 0 | 0, 2, 4, 6, 8 | 0 | 2 | 6 | 2 |
| 106 | A1 | 1 | 0 | 0, 1, 2, 3, 4, | 0 | 2 | 6 | 2 |
| | | | | 5, 6, 7, 8, 9 | | | | |
| 107 | A1 | 1 | 0 | 1, 3, 5, 7, 9 | 0 | 2 | 6 | 2 |
| 108 | A1/B1 | 2 | 0 | 4, 9 | 0 | 1 | 7 | 2 |
| 109 | A1/B1 | 2 | 0 | 4 | 0 | 2 | 7 | 2 |
| 110 | A1/B1 | 1 | 0 | 4 | 0 | 1 | 7 | 2 |
| 111 | A1/B1 | 1 | 0 | 1, 6 | 0 | 1 | 7 | 2 |
| 112 | A1/B1 | 1 | 0 | 4, 9 | 0 | 1 | 7 | 2 |
| 113 | A1/B1 | 1 | 0 | 1 | 0 | 2 | 7 | 2 |
| 114 | A1/B1 | 1 | 0 | 7 | 0 | 2 | 7 | 2 |
| 115 | A1/B1 | 1 | 0 | 1,4,7 | 0 | 2 | 7 | 2 |
| 116 | A1/B1 | 1 | 0 | 0, 2, 4, 6, 8 | 0 | 2 | 7 | 2 |
| 117 | A2 | 16 | 1 | 2, 6, 9 | 0 | 1 | 3 | 4 |
| 118 | A2 | 16 | 1 | 4 | 0 | 2 | 3 | 4 |
| 119 | A2 | 8 | 1 | 2, 6, 9 | 0 | 1 | 3 | 4 |
| 120 | A2 | 8 | 1 | 4 | 0 | 2 | 3 | 4 |
| 121 | A2 | 4 | 0 | 2, 6, 9 | 0 | 1 | 3 | 4 |
| 122 | A2 | 4 | 0 | 4 | 0 | 2 | 3 | 4 |
| 123 | A2 | 2 | 1 | 2, 6, 9 | 0 | 1 | 3 | 4 |
| 124 | A2 | 2 | 0 | 1 | 0 | 2 | 3 | 4 |
| 125 | A2 | 2 | 0 | 4 | 0 | 2 | 3 | 4 |
| 126 | A2 | 2 | 0 | 7 | 0 | 2 | 3 | 4 |
| 127 | A2 | 1 | 0 | 4 | 0 | 1 | 3 | 4 |
| 128 | A2 | 1 | 0 | 1, 6 | 0 | 1 | 3 | 4 |
| 129 | A2 | 1 | 0 | 4, 9 | 0 | 1 | 3 | 4 |
| 130 | A2 | 1 | 0 | 1 | 0 | 2 | 3 | 4 |
| 131 | A2 | 1 | 0 | 7 | 0 | 2 | 3 | 4 |
| 132 | A2 | 1 | 0 | 2, 7 | 0 | 2 | 3 | 4 |
| 133 | A2 | 1 | 0 | 1, 4, 7 | 0 | 2 | 3 | 4 |
| 134 | A2 | 1 | 0 | 0, 2, 4, 6, 8 | 0 | 2 | 3 | 4 |
| 135 | A2 | 1 | 0 | 0, 1, 2, 3, 4, | 0 | 2 | 3 | 4 |
| | | | | 5, 6, 7, 8, 9 | | | | |
| 136 | A2 | 1 | 0 | 1, 3, 5, 7, 9 | 0 | 2 | 3 | 4 |
| 137 | A2/B2 | 2 | 1 | 2, 6, 9 | 0 | 1 | 3 | 4 |
| 138 | A2/B2 | 2 | 0 | 4 | 0 | 2 | 3 | 4 |
| 139 | A2/B2 | 1 | 0 | 4 | 0 | 1 | 3 | 4 |
| 140 | A2/B2 | 1 | 0 | 1, 6 | 0 | 1 | 3 | 4 |
| 141 | A2/B2 | 1 | 0 | 4, 9 | 0 | 1 | 3 | 4 |
| 142 | A2/B2 | 1 | 0 | 1 | 0 | 2 | 3 | 4 |
| 143 | A2/B2 | 1 | 0 | 7 | 0 | 2 | 3 | 4 |
| 144 | A2/B2 | 1 | 0 | 1, 4, 7 | 0 | 2 | 3 | 4 |
| 145 | A2/B2 | 1 | 0 | 0, 2, 4, 6, 8 | 0 | 2 | 3 | 4 |
| 146 | A2/B2 | 1 | 0 | 0, 1, 2, 3, 4, | 0 | 2 | 3 | 4 |
| | | | | 5, 6, 7, 8, 9 | | | | |
| 147 | A3 | 16 | 1 | 4, 9 | 0 | 1 | 2 | 6 |
| 148 | A3 | 16 | 1 | 4 | 0 | 2 | 2 | 6 |
| 149 | A3 | 8 | 1 | 4, 9 | 0 | 2 | 2 | 6 |
| 150 | A3 | 8 | 1 | 4 | 0 | 2 | 2 | 6 |
| 151 | A3 | 4 | 0 | 4, 9 | 0 | 1 | 2 | 6 |
| 152 | A3 | 4 | 0 | 4 | 0 | 2 | 2 | 6 |
| 153 | A3 | 2 | 1 | 2, 6, 9 | 0 | 2 | 2 | 6 |
| 154 | A3 | 2 | 0 | 1 | 0 | 2 | 2 | 6 |
| 155 | A3 | 2 | 0 | 4 | 0 | 2 | 2 | 6 |
| 156 | A3 | 2 | 0 | 7 | 0 | 2 | 2 | 6 |
| 157 | A3 | 1 | 0 | 4 | 0 | 1 | 2 | 6 |
| 158 | A3 | 1 | 0 | 1, 6 | 0 | 1 | 2 | 6 |
| 159 | A3 | 1 | 0 | 4, 9 | 0 | 1 | 2 | 6 |
| 160 | A3 | 1 | 0 | 1 | 0 | 2 | 2 | 6 |
| 161 | A3 | 1 | 0 | 7 | 0 | 2 | 2 | 6 |
| 162 | A3 | 1 | 0 | 2, 7 | 0 | 2 | 2 | 6 |
| 163 | A3 | 1 | 0 | 1, 4, 7 | 0 | 2 | 2 | 6 |
| 164 | A3 | 1 | 0 | 0, 2, 4, 6, 8 | 0 | 2 | 2 | 6 |
| 165 | A3 | 1 | 0 | 0, 1, 2, 3, 4, | 0 | 2 | 2 | 6 |
| | | | | 5, 6, 7, 8, 9 | | | | |
| 166 | A3 | 1 | 0 | 1, 3, 5, 7, 9 | 0 | 2 | 2 | 6 |
| 167 | A3/B3 | 2 | 1 | 2, 6, 9 | 0 | 2 | 2 | 6 |
| 168 | A3/B3 | 2 | 0 | 4 | 0 | 2 | 2 | 6 |
| 169 | A3/B3 | 1 | 0 | 4 | 0 | 1 | 2 | 6 |
| 170 | A3/B3 | 1 | 0 | 1, 6 | 0 | 1 | 2 | 6 |
| 171 | A3/B3 | 1 | 0 | 4, 9 | 0 | 1 | 2 | 6 |
| 172 | A3/B3 | 1 | 0 | 1 | 0 | 2 | 2 | 6 |
| 173 | A3/B3 | 1 | 0 | 7 | 0 | 2 | 2 | 6 |
| 174 | A3/B3 | 1 | 0 | 1, 4, 7 | 0 | 2 | 2 | 6 |
| 175 | A3/B3 | 1 | 0 | 0, 2, 4, 6, 8 | 0 | 2 | 2 | 6 |
| 176 | A3/B3 | 1 | 0 | 0, 1, 2, 3, 4, | 0 | 2 | 2 | 6 |
| | | | | 5, 6, 7, 8, 9 | | | | |
| 177 | B1 | 16 | 0 | 4, 9 | 0 | 1 | 7 | 2 |
| 178 | B1 | 16 | 1 | 4 | 0 | 2 | 7 | 2 |
| 179 | B1 | 8 | 0 | 4, 9 | 0 | 1 | 7 | 2 |
| 180 | B1 | 8 | 1 | 4 | 0 | 2 | 7 | 2 |
| 181 | B1 | 4 | 0 | 4, 9 | 0 | 1 | 7 | 2 |
| 182 | B1 | 4 | 1 | 4, 9 | 0 | 1 | 7 | 2 |
| 183 | B1 | 4 | 0 | 4 | 0 | 2 | 7 | 2 |
| 184 | B1 | 2 | 0 | 4, 9 | 0 | 1 | 7 | 2 |
| 185 | B1 | 2 | 0 | 1 | 0 | 2 | 7 | 2 |
| 186 | B1 | 2 | 0 | 4 | 0 | 2 | 7 | 2 |
| 187 | B1 | 2 | 0 | 7 | 0 | 2 | 7 | 2 |
| 188 | B1 | 1 | 0 | 4 | 0 | 1 | 7 | 2 |
| 189 | B1 | 1 | 0 | 1, 6 | 0 | 1 | 7 | 2 |
| 190 | B1 | 1 | 0 | 4, 9 | 0 | 1 | 7 | 2 |
| 191 | B1 | 1 | 0 | 1 | 0 | 2 | 7 | 2 |
| 192 | B1 | 1 | 0 | 7 | 0 | 2 | 7 | 2 |
| 193 | B1 | 1 | 0 | 2, 7 | 0 | 2 | 7 | 2 |
| 194 | B1 | 1 | 0 | 1, 4, 7 | 0 | 2 | 7 | 2 |
| 195 | B1 | 1 | 0 | 0, 2, 4, 6, 8 | 0 | 2 | 7 | 2 |
| 196 | B1 | 1 | 0 | 0, 1, 2, 3, 4, | 0 | 2 | 7 | 2 |
| | | | | 5, 6, 7, 8, 9 | | | | |
| 197 | B1 | 1 | 0 | 1, 3, 5, 7, 9 | 0 | 2 | 7 | 2 |
| 198 | B4 | 16 | 0 | 4, 9 | 0 | 2 | 1 | 12 |
| 199 | B4 | 16 | 1 | 4 | 0 | 2 | 1 | 12 |
| 200 | B4 | 8 | 0 | 4, 9 | 0 | 2 | 1 | 12 |
| 201 | B4 | 8 | 1 | 4 | 0 | 2 | 1 | 12 |
| 202 | B4 | 4 | 0 | 4, 9 | 0 | 2 | 1 | 12 |
| 203 | B4 | 4 | 0 | 4 | 0 | 2 | 1 | 12 |
| 204 | B4 | 4 | 1 | 4, 9 | 0 | 2 | 1 | 12 |
| 205 | B4 | 2 | 0 | 4, 9 | 0 | 2 | 1 | 12 |
| 206 | B4 | 2 | 0 | 1 | 0 | 2 | 1 | 12 |
| 207 | B4 | 2 | 0 | 4 | 0 | 2 | 1 | 12 |
| 208 | B4 | 2 | 0 | 7 | 0 | 2 | 1 | 12 |
| 209 | B4 | 1 | 0 | 1 | 0 | 2 | 1 | 12 |
| 210 | B4 | 1 | 0 | 4 | 0 | 2 | 1 | 12 |
| 211 | B4 | 1 | 0 | 7 | 0 | 2 | 1 | 12 |
| 212 | B4 | 1 | 0 | 1, 6 | 0 | 2 | 1 | 12 |
| 213 | B4 | 1 | 0 | 2, 7 | 0 | 2 | 1 | 12 |
| 214 | B4 | 1 | 0 | 4, 9 | 0 | 2 | 1 | 12 |
| 215 | B4 | 1 | 0 | 1, 4, 7 | 0 | 2 | 1 | 12 |
| 216 | B4 | 1 | 0 | 0, 2, 4, 6, 8 | 0 | 2 | 1 | 12 |
| 217 | B4 | 1 | 0 | 0, 1, 2, 3, 4, | 0 | 2 | 1 | 12 |
| | | | | 5, 6, 7, 8, 9 | | | | |
| 218 | B4 | 1 | 0 | 1, 3, 5, 7, 9 | 0 | 2 | 1 | 12 |
| 219 | C0 | 8 | 1 | 4 | 0 | 2 | 7 | 2 |
| 220 | C0 | 4 | 1 | 4, 9 | 0 | 1 | 7 | 2 |
| 221 | C0 | 4 | 0 | 4 | 0 | 2 | 7 | 2 |
| 222 | C0 | 2 | 0 | 4, 9 | 0 | 1 | 7 | 2 |
| 223 | C0 | 2 | 0 | 1 | 0 | 2 | 7 | 2 |
| 224 | C0 | 2 | 0 | 4 | 0 | 2 | 7 | 2 |
| 225 | C0 | 2 | 0 | 7 | 0 | 2 | 7 | 2 |
| 226 | C0 | 1 | 0 | 4 | 0 | 1 | 7 | 2 |
| 227 | C0 | 1 | 0 | 1, 6 | 0 | 1 | 7 | 2 |
| 228 | C0 | 1 | 0 | 4, 9 | 0 | 1 | 7 | 2 |
| 229 | C0 | 1 | 0 | 1 | 0 | 2 | 7 | 2 |
| 230 | C0 | 1 | 0 | 7 | 0 | 2 | 7 | 2 |
| 231 | C0 | 1 | 0 | 2, 7 | 0 | 2 | 7 | 2 |
| 232 | C0 | 1 | 0 | 1, 4, 7 | 0 | 2 | 7 | 2 |
| 233 | C0 | 1 | 0 | 0, 2, 4, 6, 8 | 0 | 2 | 7 | 2 |
| 234 | C0 | 1 | 0 | 0, 1, 2, 3, 4, | 0 | 2 | 7 | 2 |
| | | | | 5, 6, 7, 8, 9 | | | | |
| 235 | C0 | 1 | 0 | 1, 3, 5, 7, 9 | 0 | 2 | 7 | 2 |
| 236 | C2 | 16 | 1 | 4, 9 | 0 | 1 | 2 | 6 |
| 237 | C2 | 16 | 1 | 4 | 0 | 2 | 2 | 6 |
| 238 | C2 | 8 | 1 | 4, 9 | 0 | 1 | 2 | 6 |
| 239 | C2 | 8 | 1 | 4 | 0 | 2 | 2 | 6 |
| 240 | C2 | 4 | 0 | 4, 9 | 0 | 1 | 2 | 6 |
| 241 | C2 | 4 | 0 | 4 | 0 | 2 | 2 | 6 |
| 242 | C2 | 2 | 1 | 2, 6, 9 | 0 | 2 | 2 | 6 |
| 243 | C2 | 2 | 0 | 1 | 0 | 2 | 2 | 6 |
| 244 | C2 | 2 | 0 | 4 | 0 | 2 | 2 | 6 |
| 245 | C2 | 2 | 0 | 7 | 0 | 2 | 2 | 6 |
| 246 | C2 | 1 | 0 | 4 | 0 | 1 | 2 | 6 |
| 247 | C2 | 1 | 0 | 1, 6 | 0 | 1 | 2 | 6 |
| 248 | C2 | 1 | 0 | 4, 9 | 0 | 1 | 2 | 6 |
| 249 | C2 | 1 | 0 | 1 | 0 | 2 | 2 | 6 |
| 250 | C2 | 1 | 0 | 7 | 0 | 2 | 2 | 6 |
| 251 | C2 | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | 0 | 2 | 2 | 6 |
| 254 | C2 | 1 | 0 | 0, 1, 2, 3, 4, | 0 | 2 | 2 | 6 |
| | | | | 5, 6, 7, 8, 9 | | | | |
| 255 | C2 | 1 | 0 | 1, 3, 5, 7, 9 | 0 | 2 | 2 | 6 |

TABLE 3
Table 6.3.3.2-3: Random access configurations for FRI and unpaired spectrum.

| | | | | | | Number | N^{RAslot}, | |
|---|---|---|---|---|---|---|---|---|
| | | | | | | of | number of | |
| | | | | | | PRACH | time-domain | |
| PRACH | | | | | | slots | PRACH | ${N}_{d u r}^{R A} ,$ |
| Configuration | Preamble | n_{SFN} modx = y | | Subframe | Starting | within a | ccasions within | PRACH |
| index | format | x | y | number | symbol | subframe | a PRACH slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | | | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |
| 28 | 1 | 16 | 1 | 7 | 0 | — | — | 0 |
| 29 | 1 | 8 | 1 | 7 | 0 | — | — | 0 |
| 30 | 1 | 4 | 1 | 7 | 0 | — | — | 0 |
| 31 | 1 | 2 | 0 | 7 | 0 | — | — | 0 |
| 32 | 1 | 2 | 1 | 7 | 0 | — | — | 0 |
| 33 | 1 | 1 | 0 | 7 | 0 | — | — | 0 |
| 34 | 2 | 16 | 1 | 6 | 0 | — | — | 0 |
| 35 | 2 | 8 | 1 | 6 | 0 | — | — | 0 |
| 36 | 2 | 4 | 1 | 6 | 0 | — | — | 0 |
| 37 | 2 | 2 | 0 | 6 | 7 | — | — | 0 |
| 38 | 2 | 2 | 1 | 6 | 7 | — | — | 0 |
| 39 | 2 | 1 | 0 | 6 | 7 | — | — | 0 |
| 40 | 3 | 16 | 1 | 9 | 0 | — | — | 0 |
| 41 | 3 | 8 | 1 | 9 | 0 | — | — | 0 |
| 42 | 3 | 4 | 1 | 9 | 0 | — | — | 0 |
| 43 | 3 | 2 | 0 | 9 | 0 | — | — | 0 |
| 44 | 3 | 2 | 1 | 9 | 0 | — | — | 0 |
| 45 | 3 | 2 | 0 | 4 | 0 | — | — | 0 |
| 46 | 3 | 2 | 1 | 4 | 0 | — | — | 0 |
| 47 | 3 | 1 | 0 | 9 | 0 | — | — | 0 |
| 48 | 3 | 1 | 0 | 8 | 0 | — | — | 0 |
| 49 | 3 | 1 | 0 | 7 | 0 | — | — | 0 |
| 50 | 3 | 1 | 0 | 6 | 0 | — | — | 0 |
| 51 | 3 | 1 | 0 | 5 | 0 | — | — | 0 |
| 52 | 3 | 1 | 0 | 4 | 0 | — | — | 0 |
| 53 | 3 | 1 | 0 | 3 | 0 | — | — | 0 |
| 54 | 3 | 1 | 0 | 2 | 0 | — | — | 0 |
| 55 | 3 | 1 | 0 | 1, 6 | 0 | — | — | 0 |
| 56 | 3 | 1 | 0 | 1, 6 | 7 | — | — | 0 |
| 57 | 3 | 1 | 0 | 4, 9 | 0 | — | — | 0 |
| 58 | 3 | 1 | 0 | 3, 8 | 0 | — | — | 0 |
| 59 | 3 | 1 | 0 | 2, 7 | 0 | — | — | 0 |
| 60 | 3 | 1 | 0 | 8, 9 | 0 | — | — | 0 |
| 61 | 3 | 1 | 0 | 4, 8, 9 | 0 | — | — | 0 |
| 62 | 3 | 1 | 0 | 3, 4, 9 | 0 | — | — | 0 |
| 63 | 3 | 1 | 0 | 7, 8, 9 | 0 | — | — | 0 |
| 64 | 3 | 1 | 0 | 3, 4, 8, 9 | 0 | — | — | 0 |
| 65 | 3 | 1 | 0 | 1, 4, 6, 9 | 0 | — | — | 0 |
| 66 | 3 | 1 | 0 | 1, 3, 5, 7, 9 | 0 | — | — | 0 |
| 67 | A1 | 16 | 1 | 9 | 0 | 2 | 6 | 2 |
| 68 | A1 | 8 | 1 | 9 | 0 | 2 | 6 | 2 |
| 69 | A1 | 4 | 1 | 9 | 0 | 1 | 6 | 2 |
| 70 | A1 | 2 | 1 | 9 | 0 | 1 | 6 | 2 |
| 71 | A1 | 2 | 1 | 4, 9 | 7 | 1 | 3 | 2 |
| 72 | A1 | 2 | 1 | 7, 9 | 7 | 1 | 3 | 2 |
| 73 | A1 | 2 | 1 | 7, 9 | 0 | 1 | 6 | 2 |
| 74 | A1 | 2 | 1 | 8, 9 | 0 | 2 | 6 | 2 |
| 75 | A1 | 2 | 1 | 4, 9 | 0 | 2 | 6 | 2 |
| 76 | A1 | 2 | | 2, 3, 4, 7, 8, 9 | 0 | 1 | 6 | 2 |
| 77 | A1 | 1 | 0 | 9 | 0 | 2 | 6 | 2 |
| 78 | A1 | 1 | 0 | 9 | 7 | 1 | 3 | 2 |
| 79 | A1 | 1 | 0 | 9 | 0 | 1 | 6 | 2 |
| 80 | A1 | 1 | 0 | 8, 9 | 0 | 2 | 6 | 2 |
| 81 | A1 | 1 | 0 | 4, 9 | 0 | 1 | 6 | 2 |
| 82 | A1 | 1 | 0 | 7, 9 | 7 | 1 | 3 | 2 |
| 83 | A1 | 1 | 0 | 3, 4, 8, 9 | 0 | 1 | 6 | 2 |
| 84 | A1 | 1 | 0 | 3, 4, 8, 9 | 0 | 2 | 6 | 2 |
| 85 | A1 | 1 | 0 | 1, 3, 5, 7, 9 | 0 | 1 | 6 | 2 |
| 86 | A1 | 1 | 0 | 0, 1, 2, 3, 4, | 7 | 1 | 3 | 2 |
| | | | | 5, 6, 7, 8, 9 | | | | |
| 87 | A2 | 16 | 1 | 9 | 0 | 2 | 3 | 4 |
| 88 | A2 | 8 | 1 | 9 | 0 | 2 | 3 | 4 |
| 89 | A2 | 4 | 1 | 9 | 0 | 1 | 3 | 4 |
| 90 | A2 | 2 | 1 | 7, 9 | 0 | 1 | 3 | 4 |
| 91 | A2 | 2 | 1 | 8, 9 | 0 | 2 | 3 | 1 |
| 92 | A2 | 2 | 1 | 7, 9 | 9 | 1 | 1 | 4 |
| 93 | A2 | 2 | 1 | 4, 9 | 9 | 1 | 1 | 4 |
| 94 | A2 | 2 | 1 | 4, 9 | 0 | 2 | 3 | 4 |
| 95 | A2 | 2 | 1 | 2, 3, 4, 7, 8, 9 | 0 | 1 | 3 | 4 |
| 96 | A2 | 1 | 0 | 2 | 0 | 1 | 3 | 4 |
| 97 | A2 | 1 | 0 | 7 | 0 | 1 | 3 | 4 |
| 98 | A2 | 2 | 1 | 9 | 0 | 1 | 3 | 4 |
| 99 | A2 | 1 | 0 | 9 | 0 | 2 | 3 | 4 |
| 100 | A2 | 1 | 0 | 9 | 9 | 1 | 1 | 4 |
| 101 | A2 | 1 | 0 | 9 | 0 | 1 | 3 | 4 |
| 102 | A2 | 1 | 0 | 2, 7 | 0 | 1 | 3 | 4 |
| 103 | A2 | 1 | 0 | 8, 9 | 0 | 2 | 3 | 4 |
| 104 | A2 | 1 | 0 | 4, 9 | 0 | 1 | 3 | 4 |
| 105 | A2 | 1 | 0 | 7, 9 | 9 | 1 | 1 | 4 |
| 106 | A2 | 1 | 0 | 3, 4, 8, 9 | 0 | 1 | 3 | 4 |
| 107 | A2 | 1 | 0 | 3, 4, 8, 9 | 0 | 2 | 3 | 4 |
| 108 | A2 | 1 | 0 | 1, 3, 5, 7, 9 | 0 | 1 | 3 | 4 |
| 109 | A2 | 1 | 0 | 0, 1, 2, 3, 4, | 9 | 1 | 1 | 4 |
| | | | | 5, 6, 7, 8, 9 | | | | |
| 110 | A3 | 16 | 1 | 9 | 0 | 2 | 2 | 6 |
| 111 | A3 | 8 | 1 | 9 | 0 | 2 | 2 | 6 |
| 112 | A3 | 4 | 1 | 9 | 0 | 1 | 2 | 6 |
| 113 | A3 | 2 | 1 | 4, 9 | 7 | 1 | 1 | 6 |
| 114 | A3 | 2 | 1 | 7, 9 | 7 | 1 | 1 | 6 |
| 115 | A3 | 2 | 1 | 7, 9 | 0 | 1 | 2 | 6 |
| 116 | A3 | 2 | 1 | 4, 9 | 0 | 2 | 2 | 6 |
| 117 | A3 | 2 | 1 | 8, 9 | 0 | 2 | 2 | 6 |
| 118 | A3 | 2 | 1 | 2, 3, 4, 7, 8, 9 | 0 | 1 | 2 | 6 |
| 119 | A3 | 1 | 0 | 2 | 0 | 1 | 2 | 6 |
| 120 | A3 | 1 | 0 | 7 | 0 | 1 | 2 | 6 |
| 121 | A3 | 2 | 1 | 9 | 0 | 1 | 2 | 6 |
| 122 | A3 | 1 | 0 | 9 | 0 | 2 | 2 | 6 |
| 123 | A3 | 1 | 0 | 9 | 7 | 1 | 1 | 6 |
| 124 | A3 | 1 | 0 | 9 | 0 | 1 | 2 | 6 |
| 125 | A3 | 1 | 0 | 2, 7 | 0 | 1 | 2 | 6 |
| 126 | A3 | 1 | 0 | 8, 9 | 0 | 2 | 2 | 6 |
| 127 | A3 | 1 | 0 | 4, 9 | 0 | 1 | 2 | 6 |
| 128 | A3 | 1 | 0 | 7, 9 | 7 | 1 | 1 | 6 |
| 129 | A3 | 1 | 0 | 3, 4, 8, 9 | 0 | 1 | 2 | 6 |
| 130 | A3 | 1 | 0 | 3, 4, 8, 9 | 0 | 2 | 2 | 6 |
| 131 | A3 | 1 | 0 | 1, 3, 5, 7, 9 | 0 | 1 | 2 | 6 |
| 132 | A3 | 1 | 0 | 0, 1, 2, 3, 4, | 7 | 1 | 1 | 6 |
| | | | | 5, 6, 7, 8, 9 | | | | |
| 133 | B1 | 4 | 1 | 9 | 2 | 1 | 6 | 2 |
| 134 | B1 | 2 | 1 | 9 | 2 | 1 | 6 | 2 |
| 135 | B1 | 2 | 1 | 7, 9 | 2 | 1 | 6 | 2 |
| 136 | B1 | 2 | 1 | 4, 9 | 8 | 1 | 3 | 2 |
| 137 | B1 | 2 | 1 | 4, 9 | 2 | 2 | 6 | 2 |
| 138 | B1 | 1 | 0 | 9 | 2 | 2 | 6 | 2 |
| 139 | B1 | 1 | 0 | 9 | 8 | 1 | 3 | 2 |
| 140 | B1 | 1 | 0 | 9 | 2 | 1 | 6 | 2 |
| 141 | B1 | 1 | 0 | 8, 9 | 2 | 2 | 6 | 2 |
| 142 | B1 | 1 | 0 | 4, 9 | 2 | 1 | 6 | 2 |
| 143 | B1 | 1 | 0 | 7, 9 | 8 | 1 | 3 | 2 |
| 144 | B1 | 1 | 0 | 1, 3, 5, 7, 9 | 2 | 1 | 6 | 2 |
| 145 | B4 | 16 | 1 | 9 | 0 | 2 | 1 | 12 |
| 146 | B4 | 8 | 1 | 9 | 0 | 2 | 1 | 12 |
| 147 | B4 | 4 | 1 | 9 | 2 | 1 | 1 | 12 |
| 148 | B4 | 2 | 1 | 9 | 0 | 1 | 1 | 12 |
| 149 | B4 | 2 | 1 | 9 | 2 | 1 | 1 | 12 |
| 150 | B4 | 2 | 1 | 7, 9 | 2 | 1 | 1 | 12 |
| 151 | B4 | 2 | 1 | 4, 9 | 2 | 1 | 1 | 12 |
| 152 | B4 | 2 | 1 | 4, 9 | 0 | 2 | 1 | 12 |
| 153 | B4 | 2 | 1 | 8, 9 | 0 | 2 | 1 | 12 |
| 154 | B4 | 2 | 1 | 2, 3, 4, 7, 8, 9 | 0 | 1 | 1 | 12 |
| 155 | B4 | 1 | 0 | 1 | 0 | 1 | 1 | 12 |
| 156 | B4 | 1 | 0 | 2 | 0 | 1 | 1 | 12 |
| 157 | B4 | 1 | 0 | 4 | 0 | 1 | 1 | 12 |
| 158 | B4 | 1 | 0 | 7 | 0 | 1 | 1 | 12 |
| 159 | B4 | 1 | 0 | 9 | 0 | 1 | 1 | 12 |
| 160 | B4 | 1 | 0 | 9 | 2 | 1 | 1 | 12 |
| 161 | B4 | 1 | 0 | 9 | 0 | 2 | 1 | 12 |
| 162 | B4 | 1 | 0 | 4, 9 | 2 | 1 | 1 | 12 |
| 163 | B4 | 1 | 0 | 7, 9 | 2 | 1 | 1 | 12 |
| 164 | B4 | 1 | 0 | 8, 9 | 0 | 2 | 1 | 12 |
| 165 | B4 | 1 | 0 | 3, 4, 8, 9 | 2 | 1 | 1 | 12 |
| 166 | B4 | 1 | 0 | 1, 3, 5, 7, 9 | 2 | 1 | 1 | 12 |
| 167 | B4 | 1 | 0 | 0, 1, 2, 3, 4, 5, | 0 | 2 | 1 | 12 |
| | | | | 6, 7, 8, 9 | | | | |
| 168 | B4 | 1 | 0 | 0, 1, 2, 3, 4, 5, | 2 | 1 | 1 | 12 |
| | | | | 6, 7, 8, 9 | | | | |
| 169 | C0 | 16 | 1 | 9 | 2 | 2 | 6 | 2 |
| 170 | C0 | 8 | 1 | 9 | 2 | 2 | 6 | 2 |
| 171 | C0 | 4 | 1 | 9 | 2 | 1 | 6 | 2 |
| 172 | C0 | 2 | 1 | 9 | 2 | 1 | 6 | 2 |
| 173 | C0 | 2 | 1 | 8, 9 | 2 | 2 | 6 | 2 |
| 174 | C0 | 2 | 1 | 7, 9 | 2 | 1 | 6 | 2 |
| 175 | C0 | 2 | 1 | 7, 9 | 8 | 1 | 3 | 2 |
| 176 | C0 | 2 | 1 | 4, 9 | 8 | 1 | 3 | 2 |
| 177 | C0 | 2 | 1 | 4, 9 | 2 | 2 | 6 | 2 |
| 178 | C0 | 2 | 1 | 2, 3, 4, 7, 8, 9 | 2 | 1 | 6 | 2 |
| 179 | C0 | 1 | 0 | 9 | 2 | 2 | 6 | 2 |
| 180 | C0 | 1 | 0 | 9 | 8 | 1 | 3 | 2 |
| 181 | C0 | 1 | 0 | 9 | 2 | 1 | 6 | 2 |
| 182 | C0 | 1 | 0 | 8, 9 | 2 | 2 | 6 | 2 |
| 183 | C0 | 1 | 0 | 4, 9 | 2 | 1 | 6 | 2 |
| 184 | C0 | 1 | 0 | 7, 9 | 8 | 1 | 3 | 2 |
| 185 | C0 | 1 | 0 | 3, 4, 8, 9 | 2 | 1 | 6 | 2 |
| 186 | C0 | 1 | 0 | 3, 4, 8, 9 | 2 | 2 | 6 | 2 |
| 187 | C0 | 1 | 0 | 1, 3, 5, 7, 9 | 2 | 1 | 6 | 2 |
| 188 | C0 | 1 | 0 | 0, 1, 2, 3, 4, 5, | 8 | 1 | 3 | 2 |
| | | | | 6, 7, 8, 9 | | | | |
| 189 | C2 | 16 | 1 | 9 | 2 | 2 | 2 | 6 |
| 190 | C2 | 8 | 1 | 9 | 2 | 2 | 2 | 6 |
| 191 | C2 | 4 | 1 | 9 | 2 | 1 | 2 | 6 |
| 192 | C2 | 2 | 1 | 9 | 2 | 1 | 2 | 6 |
| 193 | C2 | 2 | 1 | 8, 9 | 2 | 2 | 2 | 6 |
| 194 | C2 | 2 | 1 | 7, 9 | 2 | 1 | 2 | 6 |
| 195 | C2 | 2 | 1 | 7, 9 | 8 | 1 | 1 | 6 |
| 196 | C2 | 2 | 1 | 4, 9 | 8 | 1 | 1 | 6 |
| 197 | C2 | 2 | 1 | 4, 9 | 2 | 2 | 2 | 6 |
| 198 | C2 | 2 | 1 | 2, 3, 4, 7, 8, 9 | 2 | 1 | 2 | 6 |
| 199 | C2 | 8 | 1 | 9 | 8 | 2 | 1 | 6 |
| 200 | C2 | 4 | 1 | 9 | 8 | 1 | 1 | 6 |
| 201 | C2 | 1 | 0 | 9 | 2 | 2 | 2 | 6 |
| 202 | C2 | 1 | 0 | 9 | 8 | 1 | 1 | 6 |
| 203 | C2 | 1 | 0 | 9 | 2 | 1 | 2 | 6 |
| 204 | C2 | 1 | 0 | 8, 9 | 2 | 2 | 2 | 6 |
| 205 | C2 | 1 | 0 | 4, 9 | 2 | 1 | 2 | 6 |
| 206 | C2 | 1 | 0 | 7, 9 | 8 | 1 | 1 | 6 |
| 207 | C2 | 1 | 0 | 3, 4, 8, 9 | 2 | 1 | 2 | 6 |
| 208 | C2 | 1 | 0 | 3, 4, 8, 9 | 2 | 2 | 2 | 6 |
| 209 | C2 | 1 | 0 | 1, 3, 5, 7, 9 | 2 | 1 | 2 | 6 |
| 210 | C2 | 1 | 0 | 0, 1, 2, 3, 4, | 8 | 1 | 1 | 6 |
| | | | | 5, 6, 7, 8, 9 | | | | |
| 211 | A1/B1 | 2 | 1 | 9 | 2 | 1 | 6 | 2 |
| 212 | A1/B1 | 2 | 1 | 4, 9 | 8 | 1 | 3 | 2 |
| 213 | A1/B1 | 2 | 1 | 7, 9 | 8 | 1 | 3 | 2 |
| 214 | A1/B1 | 2 | 1 | 7, 9 | 2 | 1 | 6 | 2 |
| 215 | A1/B1 | 2 | 1 | 4, 9 | 2 | 2 | 6 | 2 |
| 216 | A1/B1 | 2 | 1 | 8, 9 | 2 | 2 | 6 | 2 |
| 217 | A1/B1 | 1 | 0 | 9 | 2 | 2 | 6 | 2 |
| 218 | A1/B1 | 1 | 0 | 9 | 8 | 1 | 3 | 2 |
| 219 | A1/B1 | 1 | 0 | 9 | 2 | 1 | 6 | 2 |
| 220 | A1/B1 | 1 | 0 | 8, 9 | 2 | 2 | 6 | 2 |
| 221 | A1/B1 | 1 | 0 | 4, 9 | 2 | 1 | 6 | 2 |
| 222 | A1/B1 | 1 | 0 | 7, 9 | 8 | 1 | 3 | 2 |
| 223 | A1/B1 | 1 | 0 | 3, 4, 8, 9 | 2 | 2 | 6 | 2 |
| 224 | A1/B1 | 1 | 0 | 1, 3, 5, 7, 9 | 2 | 1 | 6 | 2 |
| 225 | A1/B1 | 1 | 0 | 0, 1, 2, 3, 4, | 8 | 1 | 3 | 2 |
| | | | | 5, 6, 7, 8, 9 | | | | |
| 226 | A2/B2 | 2 | 1 | 9 | 0 | 1 | 3 | 4 |
| 227 | A2/B2 | 2 | 1 | 4, 9 | 6 | 1 | 2 | 4 |
| 228 | A2/B2 | 2 | 1 | 7, 9 | 6 | 1 | 2 | 4 |
| 229 | A2/B2 | 2 | 1 | 4, 9 | 0 | 2 | 3 | 4 |
| 230 | A2/B2 | 2 | 1 | 8, 9 | 0 | 2 | 3 | 4 |
| 231 | A2/B2 | 1 | 0 | 9 | 0 | 2 | 3 | 4 |
| 232 | A2/B2 | 1 | 0 | 9 | 6 | 1 | 2 | 4 |
| 233 | A2/B2 | 1 | 0 | 9 | 0 | 1 | 3 | 4 |
| 234 | A2/B2 | 1 | 0 | 8, 9 | 0 | 2 | 3 | 4 |
| 235 | A2/B2 | 1 | 0 | 4, 9 | 0 | 1 | 3 | 4 |
| 236 | A2/B2 | 1 | 0 | 7, 9 | 6 | 1 | 2 | 4 |
| 237 | A2/B2 | 1 | 0 | 3, 4, 8, 9 | 0 | 1 | 3 | 4 |
| 238 | A2/B2 | 1 | 0 | 3, 4, 8, 9 | 0 | 2 | 3 | 4 |
| 239 | A2/B2 | 1 | 0 | 1, 3, 5, 7, 9 | 0 | 1 | 3 | 4 |
| 240 | A2/B2 | 1 | 0 | 0, 1, 2, 3, 4, | 6 | 1 | 2 | 4 |
| | | | | 5, 6, 7, 8, 9 | | | | |
| 241 | A3/B3 | 2 | 1 | 9 | 0 | 1 | 2 | 6 |
| 242 | A3/B3 | 2 | 1 | 4, 9 | 2 | 1 | 2 | 6 |
| 243 | A3/B3 | 2 | 1 | 7, 9 | 0 | 1 | 2 | 6 |
| 244 | A3/B3 | 2 | 1 | 7, 9 | 2 | 1 | 2 | 6 |
| 245 | A3/B3 | 2 | 1 | 4, 9 | 0 | 2 | 2 | 6 |
| 246 | A3/B3 | 2 | 1 | 8, 9 | 0 | 2 | 2 | 6 |
| 247 | A3/B3 | 1 | 0 | 9 | 0 | 2 | 2 | 6 |
| 248 | A3/B3 | 1 | 0 | 9 | 2 | 1 | 2 | 6 |
| 249 | A3/B3 | 1 | 0 | 9 | 0 | 1 | 2 | 6 |
| 250 | A3/B3 | 1 | 0 | 8, 9 | 0 | 2 | 2 | 6 |
| 251 | A3/B3 | 1 | 0 | 4, 9 | 0 | 1 | 2 | 6 |
| 252 | A3/B3 | 1 | 0 | 7, 9 | 2 | 1 | 2 | 6 |
| 253 | A3/B3 | 1 | 0 | 3, 4, 8, 9 | 0 | 2 | 2 | 6 |
| 254 | A3/B3 | 1 | 0 | 1, 3, 5, 7, 9 | 0 | 1 | 2 | 6 |
| 255 | A3/B3 | 1 | 0 | 0, 1, 2, 3, 4, | 2 | 1 | 2 | 6 |
| | | | | 5, 6, 7, 8, 9 | | | | |
| 256 | 0 | 16 | 1 | 7 | 0 | — | — | 0 |
| 257 | 0 | 8 | 1 | 7 | 0 | — | — | 0 |
| 258 | 0 | 4 | 1 | 7 | 0 | — | — | 0 |
| 259 | 0 | 2 | 0 | 7 | 0 | — | — | 0 |
| 260 | 0 | 2 | 1 | 7 | 0 | — | — | 0 |
| 261 | 0 | 2 | 0 | 2 | 0 | — | — | 0 |
| 262 | 0 | 2 | 1 | 2 | 0 | — | — | 0 |

TABLE 4
Table 6.3.3.2-4: Random access configurations for FR2 and unpaired spectrum.

| | | | | | | | ${N}^{RA , slot} , number$ | |
|---|---|---|---|---|---|---|---|---|
| | | | | | | | of | |
| | | | | | | | time- | |
| | | | | | | Number | domain | |
| | | | | | | of | PRACH | |
| | | | | | | PRACH | ccasions | |
| PRACH | Pre- | | | | | slots | within | ${N}_{dur}^{RA} ,$ |
| Configuration | amble | n_{SFN}modx = y | | Subframe | Starting | within a | a PRACH | PRACH |
| index | format | x | y | number | symbol | subframe | slot | duration |
| 0 | A1 | 16 | 1 | 4, 9, 14, 19, | 0 | 2 | 6 | 2 |
| | | | | 24, 29, 34, 39 | | | | |
| 1 | A1 | 16 | 1 | 3, 7, 11, 15, | 0 | 1 | 6 | 2 |
| | | | | 19, 23, 27, | | | | |
| | | | | 31, 35, 39 | | | | |
| 2 | A1 | 8 | 1, 2 | 9, 19, 29, 39 | 0 | 2 | 6 | 2 |
| 3 | A1 | 8 | 1 | 4, 9, 14, 19, | 0 | 2 | 6 | 2 |
| | | | | 24, 29, 34, 39 | | | | |
| 4 | A1 | 8 | 1 | 3, 7, 11, 15, | 0 | 1 | 6 | 2 |
| | | | | 19, 23, 27, 31, | | | | |
| | | | | 35, 39 | | | | |
| 5 | A1 | 4 | 1 | 4, 9, 14, 19, | 0 | 1 | 6 | 2 |
| | | | | 24, 29, 34, 39 | | | | |
| 6 | A1 | 4 | 1 | 4, 9, 14, 19, | 0 | 2 | 6 | 2 |
| | | | | 24, 29, 34, 39 | | | | |
| 7 | A1 | 4 | 1 | 3, 7, 11, 15, | 0 | 1 | 6 | 2 |
| | | | | 19, 23, 27, 31 | | | | |
| | | | | 35, 39 | | | | |
| 8 | A1 | 2 | 1 | 7, 15, 23, 31, | 0 | 2 | 6 | 2 |
| | | | | 39 | | | | |
| 9 | A1 | 2 | 1 | 4, 9, 14, 19, | 0 | 1 | 6 | 2 |
| | | | | 24, 29, 34, 39 | | | | |
| 10 | A1 | 2 | 1 | 4, 9, 14, 19, | 0 | 2 | 6 | 2 |
| | | | | 24, 29, 34, 39 | | | | |
| 11 | A1 | 2 | 1 | 3, 7, 11, 15, | 0 | 1 | 6 | 2 |
| | | | | 19, 23, 27, 31, | | | | |
| | | | | 35, 39 | | | | |
| 12 | A1 | 1 | 0 | 19, 39 | 7 | 1 | 3 | 2 |
| 13 | A1 | 1 | 0 | 3, 5, 7 | 0 | 1 | 6 | 2 |
| 14 | A1 | 1 | 0 | 24, 29, 34, 39 | 7 | 1 | 3 | 2 |
| 15 | A1 | 1 | 0 | 9, 19, 29, 39 | 7 | 2 | 3 | 2 |
| 16 | A1 | 1 | 0 | 17, 19, 37, 39 | 0 | 1 | 6 | 2 |
| 17 | A1 | 1 | 0 | 9, 19, 29, 39 | 0 | 2 | 6 | 2 |
| 18 | A1 | 1 | 0 | 4, 9, 14, 19, | 0 | 1 | 6 | 2 |
| | | | | 24, 29, 34, 39 | | | | |
| 19 | A1 | 1 | 0 | 4, 9, 14, 19, | 7 | 1 | 3 | 2 |
| | | | | 24, 29, 34, 39 | | | | |
| 20 | A1 | 1 | 0 | 3, 5, 7, 9, | 7 | 1 | 3 | 2 |
| | | | | 11, 13 | | | | |
| 21 | A1 | 1 | 0 | 23, 27, 31, 35, | 7 | 1 | 3 | 2 |
| | | | | 39 | | | | |
| 22 | A1 | 1 | 0 | 7, 15, 23, 31, | 0 | 1 | 6 | 2 |
| | | | | 39 | | | | |
| 23 | A1 | 1 | 0 | 23, 27, 31, 35, | 0 | 1 | 6 | 2 |
| | | | | 39 | | | | |
| 24 | A1 | 1 | 0 | 13, 14, 15, 29, | 7 | 2 | 3 | 2 |
| | | | | 30, 31, 37, 38, | | | | |
| | | | | 39 | | | | |
| 25 | A1 | 1 | 0 | 3, 7, 11, 15, | 7 | 1 | 3 | 2 |
| | | | | 19, 23, 27, 31, | | | | |
| | | | | 35, 39 | | | | |
| 26 | A1 | 1 | 0 | 3, 7, 11, 15, | 0 | 1 | 6 | 2 |
| | | | | 19, 23, 27, 31, | | | | |
| | | | | 35, 39 | | | | |
| 27 | A1 | 1 | 0 | 1, 3, 5, 7, ... , | 0 | 1 | 6 | 2 |
| | | | | 37, 39 | | | | |
| 28 | A1 | 1 | 0 | 0, 1, 2, ... , 39 | 7 | 1 | 3 | 2 |
| 29 | A2 | 16 | 1 | 4, 9, 14, 19, | 0 | 2 | 3 | 4 |
| | | | | 24, 29, 34, 39 | | | | |
| 30 | A2 | 16 | 1 | 3, 7, 11, 15, | 0 | 1 | 3 | 4 |
| | | | | 19, 23, 27, 31, | | | | |
| | | | | 35, 39 | | | | |
| 31 | A2 | 8 | 1 | 4, 9, 14, 19, | 0 | 2 | 3 | 4 |
| | | | | 24, 29, 34, 39 | | | | |
| 32 | A2 | 8 | 1 | 3, 7, 11, 15, | 0 | 1 | 3 | 4 |
| | | | | 19, 23, 27, 31, | | | | |
| | | | | 35, 39 | | | | |
| 33 | A2 | 8 | 1, 2 | 9, 19, 29, 39 | 0 | 2 | 3 | 4 |
| 34 | A2 | 4 | 1 | 4, 9, 14, 19, | 0 | 1 | 3 | 4 |
| | | | | 24, 29, 34, 39 | | | | |
| 35 | A2 | 4 | 1 | 4, 9, 14, 19, | 0 | 2 | 3 | 4 |
| | | | | 24, 29, 34, 39 | | | | |
| 36 | A2 | 4 | 1 | 3, 7, 11, 15, | 0 | 1 | 3 | 4 |
| | | | | 19, 23, 27, 31, | | | | 4 |
| | | | | 35, 39 | | | | |
| 37 | A2 | 2 | 1 | 7, 15, 23, 31, 39 | 0 | 2 | 3 | 4 |
| 38 | A2 | 2 | 1 | 4, 9, 14, 19, | 0 | 1 | 3 | 4 |
| | | | | 24, 29, 34, 39 | | | | |
| 39 | A2 | 2 | 1 | 4, 9, 14, 19, | 0 | 2 | 3 | 4 |
| | | | | 24, 29, 34, 39 | | | | |
| 40 | A2 | 2 | 1 | 3, 7, 11, 15, | 0 | 1 | 3 | 4 |
| | | | | 19, 23, 27, 31, | | | | |
| | | | | 35, 39 | | | | |
| 41 | A2 | 1 | 0 | 19, 39 | 5 | 1 | 2 | 4 |
| 42 | A2 | 1 | 0 | 3, 5, 7 | 0 | 1 | 3 | 4 |
| 43 | A2 | 1 | 0 | 24, 29, 34, 39 | 5 | 1 | 2 | 4 |
| 44 | A2 | 1 | 0 | 9, 19, 29, 39 | 5 | 2 | 2 | 4 |
| 45 | A2 | 1 | 0 | 17, 19, 37, 39 | 0 | 1 | 3 | 4 |
| 46 | A2 | 1 | 0 | 9, 19, 29, 39 | 0 | 2 | 3 | 4 |
| 47 | A2 | 1 | 0 | 7, 15, 23, 31, | 0 | 1 | 3 | 4 |
| | | | | 39 | | | | |
| 48 | A2 | 1 | 0 | 23, 27, 31, 35, | 5 | 1 | 2 | 4 |
| | | | | 39 | | | | |
| 49 | A2 | 1 | 0 | 23, 27, 31, 35, | 0 | 1 | 3 | 4 |
| | | | | 39 | | | | |
| 50 | A2 | 1 | 0 | 3, 5, 7, 9, | 5 | 1 | 2 | 4 |
| | | | | 11, 13 | | | | |
| 51 | A2 | 1 | 0 | 3, 5, 7, 9, | 0 | 1 | 3 | 4 |
| | | | | 11, 13 | | | | |
| 52 | A2 | 1 | 0 | 4, 9, 14, 19, | 5 | 1 | 2 | 4 |
| | | | | 24, 29, 34, 39 | | | | |
| 53 | A2 | 1 | 0 | 4, 9, 14, 19, | 0 | 1 | 3 | 4 |
| | | | | 24, 29, 34, 39 | | | | |
| 54 | A2 | 1 | 0 | 13, 14, 15, 29, | 5 | 2 | 2 | 4 |
| | | | | 30, 31, 37, 38, | | | | |
| | | | | 39 | | | | |
| 55 | A2 | 1 | 0 | 3, 7, 11, 15, | 5 | 1 | 2 | 4 |
| | | | | 19, 23, 27, 31, | | | | |
| | | | | 35, 39 | | | | |
| 56 | A2 | 1 | 0 | 3, 7, 11, 15, | 0 | 1 | 3 | 4 |
| | | | | 19, 23, 27, 31, | | | | |
| | | | | 35, 39 | | | | |
| 57 | A2 | 1 | 0 | 1, 3, 5, 7, ... , | 0 | 1 | 3 | 4 |
| | | | | 37, 39 | | | | |
| 58 | A2 | 1 | 0 | 0, 1, 2, ... , 39 | 5 | 1 | 2 | 4 |
| 59 | A3 | 16 | 1 | 4, 9, 14, 19, | 0 | 2 | 2 | 6 |
| | | | | 24, 29, 34, 39 | | | | |
| 60 | A3 | 16 | 1 | 3, 7, 11, 15, | 0 | 1 | 2 | 6 |
| | | | | 19, 23, 27, 31, | | | | |
| | | | | 35, 39 | | | | |
| 61 | A3 | 8 | 1 | 4, 9, 14, 19, | 0 | 2 | 2 | 6 |
| | | | | 24, 29, 34, 39 | | | | |
| 62 | A3 | 8 | 1 | 3, 7, 11, 15, | 0 | 1 | 2 | 6 |
| | | | | 19, 23, 27, 31, | | | | |
| | | | | 35, 39 | | | | |
| 63 | A3 | 8 | 1, 2 | 9, 19, 29, 39 | 0 | 2 | 2 | 6 |
| 64 | A3 | 4 | 1 | 4, 9, 14, 19, | 0 | 1 | 2 | 6 |
| | | | | 24, 29, 34, 39 | | | | |
| 65 | A3 | 4 | 1 | 4, 9, 14, 19, | 0 | 2 | 2 | 6 |
| | | | | 24, 29, 34, 39 | | | | |
| 66 | A3 | 4 | 1 | 3, 7, 11, 15, 19, | 0 | 1 | 2 | 6 |
| | | | | 23, 27, 31, 35, 39 | | | | |
| 67 | A3 | 2 | 1 | 4, 9, 14, 19, | 0 | 1 | 2 | 6 |
| | | | | 24, 29, 34, 39 | | | | |
| 68 | A3 | 2 | 1 | 4, 9, 14, 19, | 0 | 2 | 2 | 6 |
| | | | | 24, 29, 34, 39 | | | | |
| 69 | A3 | 2 | 1 | 3, 7, 11, 15, 19, | 0 | 1 | 2 | 6 |
| | | | | 23, 27, 31, 35, 39 | | | | |
| 70 | A3 | 1 | 0 | 19, 39 | 7 | 1 | 1 | 6 |
| 71 | A3 | 1 | 0 | 3, 5, 7 | 0 | 1 | 2 | 6 |
| 72 | A3 | 1 | 0 | 9, 11, 13 | 2 | 1 | 2 | 6 |
| 73 | A3 | 1 | 0 | 24, 29, 34, 39 | 7 | 1 | 1 | 6 |
| 74 | A3 | 1 | 0 | 9, 19, 29, 39 | 7 | 2 | 1 | 6 |
| 75 | A3 | 1 | 0 | 17, 19, 37, 39 | 0 | 1 | 2 | 6 |
| 76 | A3 | 1 | 0 | 9, 19, 29, 39 | 0 | 2 | 2 | 6 |
| 77 | A3 | 1 | 0 | 7, 15, 23, 31, 39 | 0 | 1 | 2 | 6 |
| 78 | A3 | 1 | 0 | 23, 27, 31, 35, 39 | 7 | 1 | 1 | 6 |
| 79 | A3 | 1 | 0 | 23, 27, 31, 35, 39 | 0 | 1 | 2 | 6 |
| 80 | A3 | 1 | 0 | 3, 5, 7, 9, 11, 13 | 0 | 1 | 2 | 6 |
| 81 | A3 | 1 | 0 | 3, 5, 7, 9, 11, 13 | 7 | 1 | 1 | 6 |
| 82 | A3 | 1 | 0 | 4, 9, 14, 19, | 0 | 1 | 2 | 6 |
| | | | | 24, 29, 34, 39 | | | | |
| 83 | A3 | 1 | 0 | 4, 9, 14, 19, | 7 | 1 | 1 | 6 |
| | | | | 24, 29, 34, 39 | | | | |
| 84 | A3 | 1 | 0 | 13, 14, 15, 29, | 7 | 2 | 1 | 6 |
| | | | | 30, 31, 37, 38, 39 | | | | |
| 85 | A3 | 1 | 0 | 3, 7, 11, 15, 19, | 7 | 1 | 1 | 6 |
| | | | | 23, 27, 31, 35, 39 | | | | |
| 86 | A3 | 1 | 0 | 3, 7, 11, 15, 19, | 0 | 1 | 2 | 6 |
| | | | | 23, 27, 31, 35, 39 | | | | |
| 87 | A3 | 1 | 0 | 1, 3, 5, 7, ... , | 0 | 1 | 2 | 6 |
| | | | | 37, 39 | | | | |
| 88 | A3 | 1 | 0 | 0, 1, 2, ... , 39 | 7 | 1 | 1 | 6 |
| 89 | B1 | 16 | 1 | 4, 9, 14, 19, | 2 | 2 | 6 | 2 |
| | | | | 24, 29, 34, 39 | | | | |
| 90 | B1 | 8 | 1 | 4, 9, 14, 19, | 2 | 2 | 6 | 2 |
| | | | | 24, 29, 34, 39 | | | | |
| 91 | B1 | 8 | 1, 2 | 9, 19, 29, 39 | 2 | 2 | 6 | 2 |
| 92 | B1 | 4 | 1 | 4, 9, 14, 19, | 2 | 2 | 6 | 2 |
| | | | | 24, 29, 34, 39 | | | | |
| 93 | B1 | 2 | 1 | 4, 9, 14, 19, | 2 | 2 | 6 | 2 |
| | | | | 24, 29, 34, 39 | | | | |
| 94 | B1 | 2 | 1 | 3, 7, 11, 15, 19, | 2 | 1 | 6 | 2 |
| | | | | 23, 27, 31, 35, 39 | | | | |
| 95 | B1 | 1 | 0 | 19, 39 | 8 | 1 | 3 | 2 |
| 96 | B1 | 1 | 0 | 3, 5, 7 | 2 | 1 | 6 | 2 |
| 97 | B1 | 1 | 0 | 24, 29, 34, 39 | 8 | 1 | 3 | 2 |
| 98 | B1 | 1 | 0 | 9, 19, 29, 39 | 8 | 2 | 3 | 2 |
| 99 | B1 | 1 | 0 | 17, 19, 37, 39 | 2 | 1 | 6 | 2 |
| 100 | B1 | 1 | 0 | 9, 19, 29, 39 | 2 | 2 | 6 | 2 |
| 101 | B1 | 1 | 0 | 7, 15, 23, 31, 39 | 2 | 1 | 6 | 2 |
| 102 | B1 | 1 | 0 | 23, 27, 31, 35, 39 | 8 | 1 | 3 | 2 |
| 103 | B1 | 1 | 0 | 23, 27, 31, 35, 39 | 2 | 1 | 6 | 2 |
| 104 | B1 | 1 | 0 | 3, 5, 7, 9, 11, 13 | 8 | 1 | 3 | 2 |
| 105 | B1 | 1 | 0 | 4, 9, 14, 19, | 8 | 1 | 3 | 2 |
| | | | | 24, 29, 34, 39 | | | | |
| 106 | B1 | 1 | 0 | 4, 9, 14, 19, | 2 | 1 | 6 | 2 |
| | | | | 24, 29, 34, 39 | | | | |
| 107 | B1 | 1 | 0 | 3, 7, 11, 15, 19, | 8 | 1 | 3 | 2 |
| | | | | 23, 27, 31, 35, 39 | | | | |
| 108 | B1 | 1 | 0 | 13, 14, 15, 29, | 8 | 2 | 3 | 2 |
| | | | | 30, 31, 37, 38, 39 | | | | |
| 109 | B1 | 1 | 0 | 3, 7, 11, 15, 19, | 2 | 1 | 6 | 2 |
| | | | | 23, 27, 31, 35, 39 | | | | |
| 110 | B1 | 1 | 0 | 1, 3, 5, 7, ... , | 2 | 1 | 6 | 2 |
| | | | | 37,39 | | | | |
| 111 | B1 | 1 | 0 | 0, 1, 2, ... , 39 | 8 | 1 | 3 | 2 |
| 112 | B4 | 16 | 1, 2 | 4, 9, 14, 19, | 0 | 2 | 1 | 12 |
| | | | | 24, 29, 34, 39 | | | | |
| 113 | B4 | 16 | 1, 2 | 3, 7, 11, 15, 19, | 0 | 1 | 1 | 12 |
| | | | | 23, 27, 31, 35, 39 | | | | |
| 114 | B4 | 8 | 1, 2 | 4, 9, 14, 19, | 0 | 2 | 1 | 12 |
| | | | | 24, 29, 34, 39 | | | | |
| 115 | B4 | 8 | 1, 2 | 3, 7, 11, 15, 19, | 0 | 1 | 1 | 12 |
| | | | | 23, 27, 31, 35, 39 | | | | |
| 116 | B4 | 8 | 1, 2 | 9, 19, 29, 39 | 0 | 2 | 1 | 12 |
| 117 | B4 | 4 | 1 | 4, 9, 14, 19, | 0 | 1 | 1 | 12 |
| | | | | 24, 29, 34, 39 | | | | |
| 118 | B4 | 4 | 1 | 4, 9, 14, 19, | 0 | 2 | 1 | 12 |
| | | | | 24, 29, 34, 39 | | | | |
| 119 | B4 | 4 | 1, 2 | 3, 7, 11, 15, 19, | 0 | 1 | 1 | 12 |
| | | | | 23, 27, 31, 35, 39 | | | 1 | 12 |
| 120 | B4 | 2 | 1 | 7, 15, 23, 31, 39 | 2 | 2 | 1 | 12 |
| 121 | B4 | 2 | 1 | 4, 9, 14, 19, | 0 | 1 | 1 | 12 |
| | | | | 24, 29, 34, 39 | | | | |
| 122 | B4 | 2 | 1 | 4, 9, 14, 19, | 0 | 2 | 1 | 12 |
| | | | | 24, 29, 34, 39 | | | | |
| 123 | B4 | 2 | 1 | 3, 7, 11, 15, 19, | 0 | 1 | 1 | 12 |
| | | | | 23, 27, 31, 35, 39 | | | | |
| 124 | B4 | 1 | 0 | 19, 39 | 2 | 2 | 1 | 12 |
| 125 | B4 | 1 | 0 | 17, 19, 37, 39 | 0 | 1 | 1 | 12 |
| 126 | B4 | 1 | 0 | 24, 29, 34, 39 | 2 | 1 | 1 | 12 |
| 127 | B4 | 1 | 0 | 9, 19, 29, 39 | 2 | 2 | 1 | 12 |
| 128 | B4 | 1 | 0 | 9, 19, 29, 39 | 0 | 2 | 1 | 12 |
| 129 | B4 | 1 | 0 | 7, 15, 23, 31, 39 | 0 | 1 | 1 | 12 |
| 130 | B4 | 1 | 0 | 7, 15, 23, 31, 39 | 0 | 2 | 1 | 12 |
| 131 | B4 | 1 | 0 | 23, 27, 31, 35, 39 | 0 | 1 | 1 | 12 |
| 132 | B4 | 1 | 0 | 23, 27, 31, 35, 39 | 2 | 2 | 1 | 12 |
| 133 | B4 | 1 | 0 | 9, 11, 13, 15, 17, 19 | 0 | 1 | 1 | 12 |
| 134 | B4 | 1 | 0 | 3, 5, 7, 9, 11, 13 | 2 | 1 | 1 | 12 |
| 135 | B4 | 1 | 0 | 4, 9, 14, 19, | 0 | 1 | 1 | 12 |
| | | | | 24, 29, 34, 39 | | | | |
| 136 | B4 | 1 | 0 | 4, 9, 14, 19, | 2 | 2 | 1 | 12 |
| | | | | 24, 29, 34, 39 | | | | |
| 137 | B4 | 1 | 0 | 13, 14, 15, 29, | 2 | 2 | 1 | 12 |
| | | | | 30, 31, 37, 38, 39 | | | | |
| 138 | B4 | 1 | 0 | 3, 7, 11, 15, 19, | 0 | 1 | 1 | 12 |
| | | | | 23, 27, 31, 35, 39 | | | | |
| 139 | B4 | 1 | 0 | 3, 7, 11, 15, 19, | 2 | 1 | 1 | 12 |
| | | | | 23, 27, 31, 35, 39 | | | | |
| 140 | B4 | 1 | 0 | 3, 5, 7, ... , | 2 | 1 | 1 | 12 |
| | | | | 23, 25 | | | | |
| 141 | B4 | 1 | 0 | 3, 5, 7, ... , | 0 | 2 | 1 | 12 |
| | | | | 23, 25 | | | | |
| 142 | B4 | 1 | 0 | 1, 3, 5, 7, ... , | 0 | 1 | 1 | 12 |
| | | | | 37, 39 | | | | |
| 143 | B4 | 1 | 0 | 0, 1, 2, ... , | 2 | 1 | 1 | 12 |
| | | | | 39 | | | | |
| 144 | C0 | 16 | 1 | 4, 9, 14, 19, | 0 | 2 | 7 | 2 |
| | | | | 24, 29, 34, 39 | | | | |
| 145 | C0 | 16 | 1 | 3, 7, 11, 15, 19, | 0 | 1 | 7 | 2 |
| | | | | 23, 27, 31, 35, 39 | | | | |
| 146 | C0 | 8 | 1 | 4, 9, 14, 19, 24, | 0 | 1 | 7 | 2 |
| | | | | 29, 34, 39 | | | | |
| 147 | C0 | 8 | 1 | 3, 7, 11, 15, 19, | 0 | 1 | 7 | 2 |
| | | | | 23, 27, 31, 35, 39 | | | | |
| 148 | C0 | 8 | 1, 2 | 9, 19, 29, 39 | 0 | 2 | 7 | 2 |
| 149 | C0 | 4 | 1 | 4, 9, 14, 19, | 0 | 1 | 7 | 2 |
| | | | | 24, 29, 34, 39 | | | | |
| 150 | C0 | 4 | 1 | 4, 9, 14, 19, | 0 | 2 | 7 | 2 |
| | | | | 24, 29, 34, 39 | | | | |
| 151 | C0 | 4 | 1 | 3, 7, 11, 15, 19, | 0 | 1 | 7 | 2 |
| | | | | 23, 27, 31, 35, 39 | | | | |
| 152 | C0 | 2 | 1 | 7, 15, 23, 31, 39 | 0 | 2 | 7 | 2 |
| 153 | C0 | 2 | 1 | 4, 9, 14, 19, | 0 | 1 | 7 | 2 |
| | | | | 24, 29, 34, 39 | | | | |
| 154 | C0 | 2 | 1 | 4, 9, 14, 19, | 0 | 2 | 7 | 2 |
| | | | | 24, 29, 34, 39 | | | | |
| 155 | C0 | 2 | 1 | 3, 7, 11, 15, 19, | 0 | 1 | 7 | 2 |
| | | | | 23, 27, 31, 35, 39 | | | | |
| 156 | C0 | 1 | 0 | 19, 39 | 8 | 1 | 3 | 2 |
| 157 | C0 | 1 | 0 | 3, 5, 7 | 0 | 1 | 7 | 2 |
| 158 | C0 | 1 | 0 | 24, 29, 34, 39 | 8 | 1 | 3 | 2 |
| 159 | C0 | 1 | 0 | 9, 19, 29, 39 | 8 | 2 | 3 | 2 |
| 160 | C0 | 1 | 0 | 17, 19, 37, 39 | 0 | 1 | 7 | 2 |
| 161 | C0 | 1 | 0 | 9, 19, 29, 39 | 0 | 2 | 7 | 2 |
| 162 | C0 | 1 | 0 | 23, 27, 31, 35, 39 | 8 | 1 | 3 | 2 |
| 163 | C0 | 1 | 0 | 7, 15, 23, 31, 39 | 0 | 1 | 7 | 2 |
| 164 | C0 | 1 | 0 | 23, 27, 31, 35, 39 | 0 | 1 | 7 | 2 |
| 165 | C0 | 1 | 0 | 3, 5, 7, 9, 11, 13 | 8 | 1 | 3 | 2 |
| 166 | C0 | 1 | 0 | 4, 9, 14, 19, | 8 | 1 | 3 | 2 |
| | | | | 24, 29, 34, 39 | | | | |
| 167 | C0 | 1 | 0 | 4, 9, 14, 19, | 0 | 1 | 7 | 2 |
| | | | | 24, 29, 34, 39 | | | | |
| 168 | C0 | 1 | 0 | 13, 14, 15, 29, | 8 | 2 | 3 | 2 |
| | | | | 30, 31, 37, 38, 39 | | | | |
| 169 | C0 | 1 | 0 | 3, 7, 11, 15, 19, | 8 | 1 | 3 | 2 |
| | | | | 23, 27, 31, 35, 39 | | | | |
| 170 | C0 | 1 | 0 | 3, 7, 11, 15, 19, | 0 | 1 | 7 | 2 |
| | | | | 23, 27, 31, 35, 39 | | | | |
| 171 | C0 | 1 | 0 | 1, 3, 5, 7, ... , | 0 | 1 | 7 | 2 |
| | | | | 37, 39 | | | | |
| 172 | C0 | 1 | 0 | 0, 1, 2, ... , 39 | 8 | 1 | 3 | 2 |
| 173 | C2 | 16 | 1 | 4, 9, 14, 19, | 0 | 2 | 2 | 6 |
| | | | | 24, 29, 34, 39 | | | | |
| 174 | C2 | 16 | 1 | 3, 7, 11, 15, 19, | 0 | 1 | 2 | 6 |
| | | | | 23, 27, 31, 35, 39 | | | | |
| 175 | C2 | 8 | 1 | 4, 9, 14, 19, | 0 | 2 | 2 | 6 |
| | | | | 24, 29, 34, 39 | | | | |
| 176 | C2 | 8 | 1 | 3, 7, 11, 15, 19, | 0 | 1 | 2 | 6 |
| | | | | 23, 27, 31, 35, 39 | | | | |
| 177 | C2 | 8 | 1, 2 | 9, 19, 29, 39 | 0 | 2 | 2 | 6 |
| 178 | C2 | 4 | 1 | 4, 9, 14, 19, | 0 | 1 | 2 | 6 |
| | | | | 24, 29, 34, 39 | | | | |
| 179 | C2 | 4 | 1 | 4, 9, 14, 19, | 0 | 2 | 2 | 6 |
| | | | | 24, 29, 34, 39 | | | | |
| 180 | C2 | 4 | 1 | 3, 7, 11, 15, 19, | 0 | 1 | 2 | 6 |
| | | | | 23, 27, 31, 35, 39 | | | | |
| 181 | C2 | 2 | 1 | 7, 15, 23, 31, 39 | 2 | 2 | 2 | 6 |
| 182 | C2 | 2 | 1 | 4, 9, 14, 19, | 0 | 1 | 2 | 6 |
| | | | | 24, 29, 34, 39 | | | | |
| 183 | C2 | 2 | 1 | 4, 9, 14, 19, | 0 | 2 | 2 | 6 |
| | | | | 24, 29, 34, 39 | | | | |
| 184 | C2 | 2 | 1 | 3, 7, 11, 15, 19, | 0 | 1 | 2 | 6 |
| | | | | 23, 27, 31, 35, 39 | | | | |
| 185 | C2 | 1 | 0 | 19, 39 | 2 | 1 | 2 | 6 |
| 186 | C2 | 1 | 0 | 3, 5, 7 | 0 | 1 | 2 | 6 |
| 187 | C2 | 1 | 0 | 24, 29, 34, 39 | 7 | 1 | 1 | 6 |
| 188 | C2 | 1 | 0 | 9, 19, 29, 39 | 7 | 2 | 1 | 6 |
| 189 | C2 | 1 | 0 | 17, 19, 37, 39 | 0 | 1 | 2 | 6 |
| 190 | C2 | 1 | 0 | 9, 19, 29, 39 | 2 | 2 | 2 | 6 |
| 191 | C2 | 1 | 0 | 7, 15, 23, | 2 | 1 | 2 | 6 |
| | | | | 31, 39 | | | | |
| 192 | C2 | 1 | 0 | 3, 5, 7, 9, 11, 13 | 7 | 1 | 1 | 6 |
| 193 | C2 | 1 | 0 | 23, 27, 31, 35, 39 | 7 | 2 | 1 | 6 |
| 194 | C2 | 1 | 0 | 23, 27, 31, 35, 39 | 0 | 1 | 2 | 6 |
| 195 | C2 | 1 | 0 | 4, 9, 14, 19, 24, | 7 | 2 | 1 | 6 |
| | | | | 29, 34, 39 | | | | |
| 196 | C2 | 1 | 0 | 4, 9, 14, 19, | 2 | 1 | 2 | 6 |
| | | | | 24, 29, 34, 39 | | | | |
| 197 | C2 | 1 | 0 | 13, 14, 15, 29, | 7 | 2 | 1 | 6 |
| | | | | 30, 31, 37, 38, 39 | | | | |
| 198 | C2 | 1 | 0 | 3, 7, 11, 15, 19, | 7 | 1 | 1 | 6 |
| | | | | 23, 27, 31, 35, 39 | | | | |
| 199 | C2 | 1 | 0 | 3, 7, 11, 15, 19, | 0 | 1 | 2 | 6 |
| | | | | 23, 27, 31, 35, 39 | | | | |
| 200 | C2 | 1 | 0 | 1 ,3, 5, 7, ... , | 0 | 1 | 2 | 6 |
| | | | | 37, 39 | | | | |
| 201 | C2 | 1 | 0 | 0, 1, 2, ... , 39 | 7 | 1 | 1 | 6 |
| 202 | A1/B1 | 16 | 1 | 4, 9, 14, 19, 24, | 2 | 1 | 6 | 2 |
| | | | | 29, 34, 39 | | | | |
| 203 | A1/B1 | 16 | 1 | 3, 7, 11, 15, 19, | 2 | 1 | 6 | 2 |
| | | | | 23, 27, 31, 35, 39 | | | | |
| 204 | A1/B1 | 8 | 1 | 4, 9, 14, 19, | 2 | 1 | 6 | 2 |
| | | | | 24, 29, 34, 39 | | | | |
| 205 | A1/B1 | 8 | 1 | 3, 7, 11, 15, 19, | 2 | 1 | 6 | 2 |
| | | | | 23, 27, 31, 35, 39 | | | | |
| 206 | A1/B1 | 4 | 1 | 4, 9, 14, 19, | 2 | 1 | 6 | 2 |
| | | | | 24, 29, 34, 39 | | | | |
| 207 | A1/B1 | 4 | 1 | 3, 7, 11, 15, 19, | 2 | 1 | 6 | 2 |
| | | | | 23, 27, 31, 35, 39 | | | | |
| 208 | A1/B1 | 2 | 1 | 4, 9, 14, 19, 24, 29, | 2 | 1 | 6 | 2 |
| | | | | 34, 39 | | | | |
| 209 | A1/B1 | 1 | 0 | 19, 39 | 8 | 1 | 3 | 2 |
| 210 | A1/B1 | 1 | 0 | 9, 19, 29, 39 | 8 | 1 | 3 | 2 |
| 211 | A1/B1 | 1 | 0 | 17, 19, 37, 39 | 2 | 1 | 6 | 2 |
| 212 | A1/B1 | 1 | 0 | 9, 19, 29, 39 | 2 | 2 | 6 | 2 |
| 213 | A1/B1 | 1 | 0 | 23, 27, 31, 35, 39 | 8 | 1 | 3 | 2 |
| 214 | A1/B1 | 1 | 0 | 7, 15, 23, 31, 39 | 2 | 1 | 6 | 2 |
| 215 | A1/B1 | 1 | 0 | 23, 27, 31, 35, 39 | 2 | 1 | 6 | 2 |
| 216 | A1/B1 | 1 | 0 | 4, 9, 14, 19, | 8 | 1 | 3 | 2 |
| | | | | 24, 29, 34, 39 | | | | |
| 217 | A1/B1 | 1 | 0 | 4, 9, 14, 19, | 2 | 1 | 6 | 2 |
| | | | | 24, 29, 34, 39 | | | | |
| 218 | A1/B1 | 1 | 0 | 3, 7, 11, 15, 19, | 2 | 1 | 6 | 2 |
| | | | | 23, 27, 31, 35, 39 | | | | |
| 219 | A1/B1 | 1 | 0 | 1, 3, 5, 7, ... , | 2 | 1 | 6 | 2 |
| | | | | 37, 39 | | | | |
| 220 | A2/B2 | 16 | 1 | 4, 9, 14, 19, | 2 | 1 | 3 | 4 |
| | | | | 24, 29, 34, 39 | | | | |
| 221 | A2/B2 | 16 | 1 | 3, 7, 11, 15, 19, | 2 | 1 | 3 | 4 |
| | | | | 23, 27, 31, 35, 39 | | | | |
| 222 | A2/B2 | 8 | 1 | 4, 9, 14, 19, | 2 | 1 | 3 | 4 |
| | | | | 24, 29, 34, 39 | | | | |
| 223 | A2/B2 | 8 | 1 | 3, 7, 11, 15, 19, | 2 | 1 | 3 | 4 |
| | | | | 23, 27, 31, 35, 39 | | | | |
| 224 | A2/B2 | 4 | 1 | 4, 9, 14, 19, | 2 | 1 | 3 | 4 |
| | | | | 24, 29, 34, 39 | | | | |
| 225 | A2/B2 | 4 | 1 | 3, 7, 11, 15, 19, | 2 | 1 | 3 | 4 |
| | | | | 23, 27, 31, 35, 39 | | | | 4 |
| 226 | A2/B2 | 2 | 1 | 4, 9, 14, 19, | 2 | 1 | 3 | 4 |
| | | | | 24, 29, 34, 39 | | | | |
| 227 | A2/B2 | 1 | 0 | 19, 39 | 6 | 1 | 2 | 4 |
| 228 | A2/B2 | 1 | 0 | 9, 19, 29, 39 | 6 | 1 | 2 | 4 |
| 229 | A2/B2 | 1 | 0 | 17, 19, 37, 39 | 2 | 1 | 3 | 4 |
| 230 | A2/B2 | 1 | 0 | 9, 19, 29, 39 | 2 | 2 | 3 | 4 |
| 231 | A2/B2 | 1 | 0 | 23, 27, 31, 35, 39 | 6 | 1 | 2 | 4 |
| 232 | A2/B2 | 1 | 0 | 7, 15, 23, 31, 39 | 2 | 1 | 3 | 4 |
| 233 | A2/B2 | 1 | 0 | 23, 27, 31, 35, 39 | 2 | 1 | 3 | 4 |
| 234 | A2/B2 | 1 | 0 | 4, 9, 14, 19, | 6 | 1 | 2 | 4 |
| | | | | 24, 29, 34, 39 | | | | |
| 235 | A2/B2 | 1 | 0 | 4, 9, 14, 19, | 2 | 1 | 3 | 4 |
| | | | | 24, 29, 34, 39 | | | | |
| 236 | A2/B2 | 1 | 0 | 3, 7, 11, 15, 19, | 2 | 1 | 3 | 4 |
| | | | | 23, 27, 31, 35, 39 | | | | |
| 237 | A2/B2 | 1 | 0 | 1, 3, 5, 7, ... , | 2 | 1 | 3 | 4 |
| | | | | 37, 39 | | | | |
| 238 | A3/B3 | 16 | 1 | 4, 9, 14, 19, | 2 | 1 | 2 | 6 |
| | | | | 24, 29, 34, 39 | | | | |
| 239 | A3/B3 | 16 | 1 | 3, 7, 11, 15, 19, | 2 | 1 | 2 | 6 |
| | | | | 23, 27, 31, 35, 39 | | | | |
| 240 | A3/B3 | 8 | 1 | 4, 9, 14, 19, | 2 | 1 | 2 | 6 |
| | | | | 24, 29, 34, 39 | | | | |
| 241 | A3/B3 | 8 | 1 | 3, 7, 11, 15, 19, | 2 | 1 | 2 | 6 |
| | | | | 23, 27, 31, 35, 39 | | | | |
| 242 | A3/B3 | 4 | 1 | 4, 9, 14, 19, | 2 | 1 | 2 | 6 |
| | | | | 24, 29, 34, 39 | | | | |
| 243 | A3/B3 | 4 | 1 | 3, 7, 11, 15, 19, | 2 | 1 | 2 | 6 |
| | | | | 23, 27, 31, 35, 39 | | | | |
| 244 | A3/B3 | 2 | 1 | 4, 9, 14, 19, | 2 | 1 | 2 | 6 |
| | | | | 24, 29, 34, 39 | | | | |
| 245 | A3/B3 | 1 | 0 | 19, 39 | 2 | 1 | 2 | 6 |
| 246 | A3/B3 | 1 | 0 | 9, 19, 29, 39 | 2 | 1 | 2 | 6 |
| 247 | A3/B3 | 1 | 0 | 17, 19, 37, 39 | 2 | 1 | 2 | 6 |
| 248 | A3/B3 | 1 | 0 | 9, 19, 29, 39 | 2 | 2 | 2 | 6 |
| 249 | A3/B3 | 1 | 0 | 7, 15, 23, 31, 39 | 2 | 1 | 2 | 6 |
| 250 | A3/B3 | 1 | 0 | 23, 27, 31, 35, 39 | 2 | 1 | 2 | 6 |
| 251 | A3/B3 | 1 | 0 | 23, 27, 31, 35, 39 | 2 | 2 | 2 | 6 |
| 252 | A3/B3 | 1 | 0 | 4, 9, 14, 19, | 2 | 1 | 2 | 6 |
| | | | | 24, 29, 34, 39 | | | | |
| 253 | A3/B3 | 1 | 0 | 4, 9, 14, 19, | 2 | 2 | 2 | 6 |
| | | | | 24, 29, 34, 39 | | | | |
| 254 | A3/B3 | 1 | 0 | 3, 7, 11, 15, 19, | 2 | 1 | 2 | 6 |
| | | | | 23, 27, 31, 35, 39 | | | | |
| 255 | A3/B3 | 1 | 0 | 1, 3, 5, 7,... , | 2 | 1 | 2 | 6 |
| | | | | 37, 39 | | | | |

For example, in embodiments described below, the ROs may be ROs based on one of Tables 2 to 4 above.

The contents described above can be applied by being combined with methods according to the present disclosure described below, or can be supplemented to clarify technical features of methods described in the present disclosure.

In addition, methods related to configuration of a PRACH transmission occasion described below are related to uplink transmission and can be equally applied to an uplink signal transmission method in the NR system (licensed band) or U-Band system (unlicensed band) described above. The technical ideas described in the present disclosure can be modified or replaced to suit terms, expressions, structures, etc. defined in each system so that they can be implemented in the corresponding systems.

For example, the uplink transmission through the methods related to configuration of the PRACH transmission occasion described below can be performed in an L-cell (cell operating in the licensed band (L-band)) and/or a U-cell (cell operating in the unlicensed band (U-band)) defined in the NR system or the U-Band system.

NR supports multiple numerologies (or subcarrier spacing (SCS)) for supporting diverse 5G services. For example, if the SCS is 15 kHz, the NR supports a wide area in conventional cellular bands; if the SCS is 30 kHz/60 kHz, the NR supports a dense-urban, lower latency and wider carrier bandwidth; and if the SCS is 60 kHz or higher, the NR supports a bandwidth greater than 24.25 GHz to overcome phase noise.

An NR frequency band is defined as two types of frequency ranges FR1 and FR2. FR1 and FR2 may be configured as shown in Table 5 below. FR2 may mean millimeter wave (mmW).

TABLE 5

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHz | 60, 120, 240 | kHz |

Hereinafter, when a PRACH repetition scheme is introduced for coverage enhancement in NR, a RACH resource partitioning method for PRACH repetition and a related UE/base station operation are proposed. In the present disclosure, ‘PRACH transmission’, ‘RACH transmission’ or ‘preamble transmission’ may be interpreted/replaced as ‘MSG1 transmission’.

Various RAN1 work items are defined to distinguish UE/base station operations based on a RACH resource (e.g., PRACH preamble index, etc.). As an example, UEs related to redcap, small data transmission, Msg. 3 PUSCH repetition, etc., are defined to select a specific preamble index to request from the base station whether to use a corresponding feature in a PRACH preamble transmission step. However, when each operation separately created for each work item are defined, an implementation complexity of the UE/base station may be increased.

Therefore, a concept of “Feature Combination” has been introduced to efficiently support UE/base station operations that need to be distinguished by using the RACH resource (e.g., PRACH preamble index, etc.) in a RAN2 Rel-17 RACH partitioning work item. That is, the base station configures/indicates to the UE that a specific feature or a combination of specific features is supported by configuring a specific PRACH resource (e.g., preamble start index and total number indication). The UE that intends to use/request a specific feature and/or a combination of specific features may select one of preamble indices of a region allocated to the specific feature and/or the combination of the specific features desired by itself during the RACH procedure to transmit a PRACH preamble. RRC parameters for this operation may be “FeatureCombinationPreambles” and “FeatureCombination”. Table 6 below shows the “FeatureCombinationPreambles” and “FeatureCombination”.

TABLE 6

| | |
|---|---|
| FeatureCombinationPreambles-r17 ::= | SEQUENCE { |
| featureCombination-r17 | FeatureCombination-r17, |
| startPreambleForThisPartition-r17 | INTEGER (1..64), |

numberOfPreamblesPerSSB-ForThisPartition-r17 INTEGER (1..64),

| | |
|---|---|
| ssb-SharedRO-MaskIndex-r17 | INTEGER (1..15) |
| OPTIONAL, -- Need S | |
| groupBconfigured-r17 | SEQUENCE { |
| ra-SizeGroupA-r17 | ENUMERATED {b56, b144, b208, |

b256, b282, b480, b640, b800, b1000, b72, spare6, spare5, spare4, spare3, spare2,

| | |
|---|---|
| spare1}, | |
| messagePowerOffsetGroupB | ENUMERATED { minusinfinity, |

dB0, dBS, dB8, dB10, dB12, dBIS, dB18},

| | |
|---|---|
| numberOfRA-PreamblesGroupA | INTEGER (1..64) |
| } | |
| OPTIONAL, -- Need S | |
| separateMsgA-PUSCH-Config-r17 | MsgA-PUSCH-Config-r16 |

OPTIONAL, -- Cond MsgA ConfigCommon

| | |
|---|---|
| msgA-RSRP-Threshold-r17 | RSRP-Range |
| OPTIONAL, -- Need R | |
| rsrp-ThresholdSSB-r17 | RSRP-Range |
| OPTIONAL, -- Need R | |
| deltaPreamble-r17 | INTEGER (−1..6) |
| OPTIONAL, -- Need R | |
| ... | |
| } | |

FeatureCombination-r17 ::= SEQUENCE {

| | |
|---|---|
| redCap-r17 | ENUMERATED {true} |
| OPTIONAL, -- Need R | |
| smallData-r17 | ENUMERATED {true} |
| OPTIONAL, -- Need R | |
| nsag-r17 | NSAG-List-r17 |
| OPTIONAL, -- Need R | |
| msg3-Repetitions-r17 | ENUMERATED {true} |
| OPTIONAL, -- Need R | |
| spare4 | ENUMERATED {true} |
| OPTIONAL, -- Need R | |
| spare3 | ENUMERATED {true} |
| OPTIONAL, -- Need R | |
| spare2 | ENUMERATED {true} |
| OPTIONAL, -- Need R | |
| spare1 | ENUMERATED {true} |
| OPTIONAL -- Need R | |
| } | |

A plurality of FeatureCombinationPreambles parameters may be configured within RACH-ConfigCommon. Preamble index intervals corresponding to each region (i.e., a region/partition based on a preamble(s) belonging to each of the plurality of FeatureCompanyPreamble parameters) need to be configured not to overlap. In addition, features and/or combinations of features configured in respective regions also need to be configured to not overlap with each other. As described above, the parameter(s) for the random access procedure may be initialized/determined based on the RACH resource(s) (e.g., preamble(s)) selected by the UE.

In the present disclosure, a ‘RACH resource’ (or ‘PRACH resource’) may be interpreted/replaced as a random access resource. For example, a FeatureCombination (e.g., a feature or a combination of features) related to RACH resources may be interpreted/replaced as FeatureCombination related to a set of random access resources.

Meanwhile, in addition to the RACH-ConfigCommon allocated to existing BWP-UplinkCommon, the base station may additionally allocate a RACH configuration through AdditionalRACH-Config-r17. The BWP-UplinkCommon may be configured based on an SIB (e.g., SIBI). The RACH procedure may be performed as follows by a Rel-16 UE/Rel-17 UE.

For Rel-16 UEs that may not read AdditionalRACH-Config-r17, the UEs perform the RACH procedure based on RACH-ConfigCommon allocated to BWP-UplinkCommon.

For UEs of Rel-17 and later that may read AdditionalRACH-Config-r17, the UEs perform the RACH procedure by confirming RACH-ConfigCommon allocated to the existing BWP-UplinkCommon and RACH-ConfigCommon allocated to the AdditionalRACH-Config-r17.

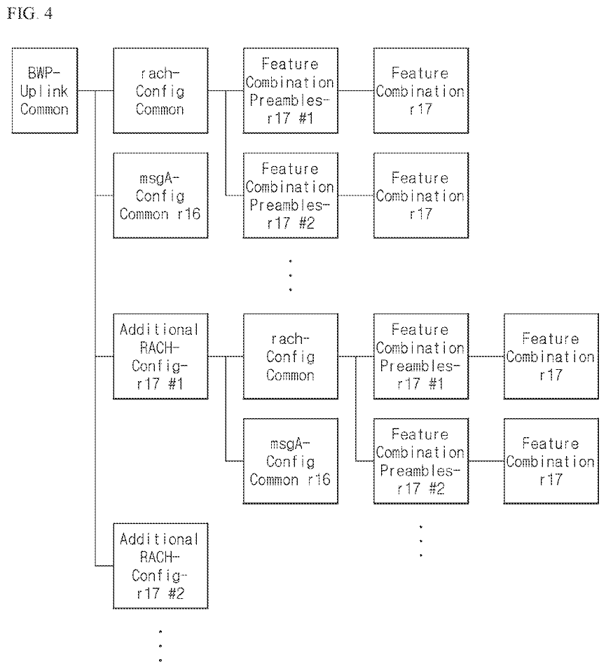

In addition, one or more FeatureCombinationPreambles described above may be configured in the RACH-ConfigCommon allocated to the existing BWP-UplinkCommon. One or more FeatureCombinationPreambles described above may be also configured in the RACH-ConfigCommon allocated to the AdditionalRACH-Config-r17. Hereinafter, this will be described with reference to FIG. 4.

FIG. 4 illustrates an RACH partitioning related RRC parameter. Specifically, FIG. 4 illustrates a connection relationship/up-and-down relationship of the RACH partitioning related RRC parameters.

Respective parameters will be specifically described with reference to FIG. 4. For convenience of description, an RRC parameter (e.g., BWP-UplinkCommon parameter) is described as a parameter name (e.g., BWP-UplinkCommon).

The BWP-UplinkCommon includes i) rach-ConfigCommon, ii) msgA-ConfigCommon, and iii) one or more AdditionalRACH-Config #1, #2, . . . .

Each AdditionalRACH-Config includes i) rach-ConfigCommon and ii) msgA-ConfigCommo.

Each rach-ConfigCommon includes one or more FeatureConbinationPreambles.

Each FeatureConbinationPreambles includes FeatureCombination.

Table 7 shows the RRC parameters described above.

TABLE 7
- BWP-UplinkCommon
The IE BWP-UplinkCommon is used to configure the common parameters of an
uplink BWP. They are “cell specific” and the network ensures the necessary
alignment with corresponding parameters of other UEs. The common parameters
of the initial bandwidth part of the PCell are also provided via system information.
For all other serving cells, the network provides the common parameters via
dedicated signalling.

| | |
|---|---|
| BWP-UplinkCommon ::= | SEQUENCE { |
| genericParameters | BWP, |
| rach-ConfigCommon | SetupRelease { RACH- |
| ConfigCommon } | OPTIONAL, |
| -- Need M | |
| pusch-ConfigCommon | SetupRelease { PUSCH- |
| ConfigCommon | OPTIONAL, |
| -- Need M | |
| pucch-ConfigCommon | SetupRelease { PUCCH- |
| ConfigCommon } | OPTIONAL, |
| -- Need M | |
| ..., | |
| [[ | |
| rach-ConfigCommonIAB-r16 | SetupRelease { RACH- |
| ConfigCommon } | OPTIONAL, |
| -- Need M | |
| useInterlacePUCCH-PUSCH-r16 | ENUMERATED {enabled} |
| OPTIONAL, -- Need R | |
| msgA-ConfigCommon-r16 | SetupRelease { MsgA- |
| ConfigCommon-r16 } | OPTIONAL, |
| -- Cond SpCellOnly2 | |
| ]], | |
| [[ | |
| enableRA-PrioritizationForSlicing-r17 | BOOLEAN |
| OPTIONAL, -- Cond RA-PrioSliceAI | |
| additionalRACH-ConfigList-r17 | SetupRelease |
| { AdditionalRACH-ConfigList-r17 } | OPTIONAL, -- Cond |
| SpCellOnly2 | |
| rsrp-ThresholdMsg3-r17 | RSRP-Range |
| OPTIONAL, -- Need R | |
| numberOfMsg3-RepetitionsList-r17 | SEQUENCE (SIZE (4)) OF |
| NumberOfMsg3-Repetitions-r17 | OPTIONAL, -- Cond |
| Msg3Rep | |
| mcs-Msg3-Repetitions-r17 | SEQUENCE (SIZE (8)) OF |
| INTEGER (0..31) | OPTIONAL -- Cond |
| Msg3Rep | |
| ]], | |
| [[ | |

```
  additionalRACH-perPCI-ToAddModList-r18 SEQUENCE (SIZE (1..
maxNrofAdditionalPRACHConfigs-r18)) OF RACH-ConfigTwoTA-r18
OPTIONAL, -- Cond 2TA-Only
  additionalRACH-perPCI-ToReleaseList-r18 SEQUENCE (SIZE (1..
maxNrofAdditionalPRACHConfigs-r18)) OF RACH-ConfigTwoTAIndex-r18
```

| | |
|---|---|
| OPTIONAL, -- Need N | |
| rsrp-Threshold Msg1-RepetitionNum2-r18 | RSRP-Range |
| OPTIONAL, -- Cond Msg1Rep1 | |
| rsrp-ThresholdMsg1-RepetitionNum4-r18 | RSRP-Range |
| OPTIONAL, -- Cond Msg1Rep1 | |
| rsrp-ThresholdMsg1-RepetitionNum8-r18 | RSRP-Range |
| OPTIONAL, -- Cond Msg1Rep1 | |
| preamble TransMax-Msg1-Repetition-r18 | ENUMERATED {n1, n2, |
| n4, n6, n8, n10, n20, n50, n100, n200} | OPTIONAL -- Cond |
| Msg1Rep1 | |
| ]] | |
| } | |
| AdditionalRACH-ConfigList-r17 | SEQUENCE |

(SIZE(1..maxAdditionalRACH-r17)) OF AdditionalRACH-Config-r17

| | |
|---|---|
| AdditionalRACH-Config-r17 ::= | SEQUENCE { |
| rach-ConfigCommon-r17 | RACH-ConfigCommon |
| OPTIONAL, -- Need R | |
| msgA-ConfigCommon-r17 | MsgA-ConfigCommon-r16 |
| OPTIONAL, -- Need R | |
| ... | |
| } | |
| NumberOfMsg3-Repetitions-r17::= | ENUMERATED {n1, n2, n3, |
| n4, n7, n8, n12, n16} | |

BWP-UplinkCommon field descriptions
additionalRACH-ConfigList
List of feature or feature combination-specific RACH configurations, i.e. the
RACH configurations configured in addition to the one configured by rach-
ConfigCommon and by msgA-ConfigCommon. The network associates all
possible preambles of an additional RACH configuration to one or more
feature(s) or feature combination(s). The network does not configure this list to
have more than 32 entries. If both rach-ConfigCommon and msgA-
ConfigCommon are configured for a specific FeatureCombination, the network
always provides them in the same additionalRACH-Config.
additionalRACH-perPCI-ToAddModList
List of RACH configurations for the additional PCIs. The RACH configuration
for an additional PCI is applied for Random Access procedure initiated by
PDCCH order towards to the additional PCI, as specified in TS 38.321 clause
5.1.1b. This configuration may be different for different UEs.
enableRA-Prioritization ForSlicing
Indicates whether or not the ra-PrioritizationForSlicing/ra-
PrioritizationForSlicingTwoStep should override the ra-
PrioritizationFor AccessIdentity. The field is applicable only when the UE is
configured by upper layers with both NSAG and Access Identity 1 or 2. If
value TRUE is configured, the UE should only apply the ra-
PrioritizationForSlicing/ra-PrioritizationForSlicingTwoStep. If value FALSE
is configured, the UE should only apply ra-PrioritizationFor AccessIdentity. If
the field is absent, whether to use ra-PrioritizationForSlicing/ra-
PrioritizationForSlicingTwoStep or ra-PrioritizationFor AccessIdentity is up to
UE implementation.
mcs-Msg3-Repetitions
Configuration of eight candidate MCS indexes for PUSCH transmission
scheduled by RAR UL grant and DCI format 0 0 with CRC scrambled by TC-
RNTI. Only the first 4 configured or default MCS indexes are used for PUSCH
transmission scheduled by RAR UL grant. This field is only applicable when
the UE selects Random Access resources indicating Msg3 repetition in this
BWP. If this field is absent when the set(s) of Random Access resources with
MSG3 repetition indication are configured in the BWP-UplinkCommon, the UE
shall apply the values {0, 1, 2, 3, 4, 5, 6, 7} (see TS 38.214 [19], clause 6.1.4).
msgA-ConfigConunon
Configuration of the cell specific PRACH and PUSCH resource parameters for
transmission of MsgA in 2-step random access type procedure. The NW can
configure msgA-ConfigCommon only for UL BWPs if the linked DL BWPs
(same bwp-Id as UL-BWP) are the initial DL BWPs or DL BWPs containing
the SSB associated to the initial DL BWP or DL BWPs associated with
nonCellDefiningSSB or, for (e)RedCap UEs, the (e)RedCap-specific initial
downlink BWP.
numberOfMsg3-RepetitionsList
The number of repetitions for PUSCH transmission scheduled by RAR UL
grant and DCI format 0 0 with CRC scrambled by TC-RNTI. This field is only
applicable when the UE selects Random Access resources indicating Msg3
repetition in this BWP. If this field is absent when the set(s) of Random Access
resources with MSG3 repetition indication are configured in the BWP-
UplinkCommon, the UE shall apply the values {n1, n2, n3, n4} (see TS 38.214
[19], clause 6.1.2.1).
preambleTransMax-Msg1-Repetition
Max number of transmissions of MSGI repetitions number (2, 4 and 8)
performed before switching to higher repetition number (see TS 38.321 [3],
clauses 5.1.1). This field is only applicable when more than one repetition
numbers are configured in shared RO. If the field is absent, switching from
lower repetition number to higher repetition number is not allowed.
pucch-ConfigConumnon
Cell specific parameters for the PUCCH of this BWP.
pusch-ConfigCommon
Cell specific parameters for the PUSCH of this BWP.
rach-ConfigCommon
Configuration of cell specific random access parameters which the UE uses for
contention based and contention free random access as well as for contention
based beam failure recovery in this BWP. The NW configures SSB-based RA
(and hence RACH-ConfigCommon) only for UL BWPs if the linked DL BWPs
(same bwp-Id as UL-BWP) are the initial DL BWPs or DL BWPs containing
the SSB associated to the initial DL BWP or DL BWPs associated with
nonCellDefiningSSB or, for (e)RedCap UEs, the (e)RedCap-specific initial
downlink BWP. The network configures rach-ConfigCommon, whenever it
configures contention free random access (for reconfiguration with sync or for
beam failure recovery). For (e)RedCap-specific initial uplink BWP, rach-
ConfigCommon is always configured when msgA-ConfigCommon is
configured in this BWP.
rach-ConfigCommonIAB
Configuration of cell specific random access parameters for the IAB-MT. The
IAB specific IAB RACH configuration is used by IAB-MT, if configured.
rsrp-ThresholdMsg1-Repetition Num2, rsrp-ThresholdMsg1-RepetitionNum4,
rsrp-ThresholdMsg1-Repetition Num8
Threshold used by the UE for determining whether to select resources indicating
Msg1 repetition number 2, 4 or 8 in this BWP, as specified in TS 38.321 [3].
The value applies to all the BWPs and all RACH configurations. This field is
mandatory if both set(s) of Random Access resources with MSG1 repetition
indication and set(s) of Random Access resources without MSG1 repetition
indication are configured in the BWP, or if all set(s) of Random Access
resources are configured with MSGI repetition indication but associated with
different repetition numbers in the BWP. It is absent otherwise.
rsrp-ThresholdMsg3
Threshold used by the UE for determining whether to select resources indicating
Msg3 repetition in this BWP, as specified in TS 38.321 [3]. The field is
mandatory if both set(s) of Random Access resources with MSG3 repetition
indication and set(s) of Random Access resources without MSG3 repetition
indication are configured in the BWP. It is absent otherwise.
useInterlacePUCCH-PUSCH
If the field is present, the UE uses uplink frequency domain resource allocation
Type 2 for cell-specific PUSCH, e.g., PUSCH scheduled by RAR UL grant (see
TS 38.213 [13] clause 8.3 and TS 38.214 [19], clause 6.1.2.2) and uses
interlaced PUCCH Format 0 and 1 for cell-specific PUCCH (see TS 38.213
[13], clause 9.2.1).

| Conditional | |
|---|---|
| Presence | Explanation |
| Msg1Rep1 | This field is optionally present, Need R, if the set(s) of |
| | Random Access resources with MSGI repetition |
| | indication are configured in the BWP-UplinkCommon. It |
| | is absent otherwise. |
| Msg3Rep | This field is optionally present, Need S, if the set(s) of |
| | Random Access resources with MSG3 repetition |
| | indication are configured in the BWP-UplinkCommon. It |
| | is absent otherwise. |
| RA-PrioSliceAI | The field is optionally present in SIBI, Need R, if both |
| | parameters ra-PrioritizationFor AccessIdentity and the |
| | ra-PrioritizationFor Slicing/ra- |
| | Prioritization ForSlicingTwoStep are present in SIBI. It |
| | is absent otherwise. |
| SpCellOnly2 | The field is optionally present, Need M, in the BWP- |
| | UplinkCommon of an SpCell. It is absent otherwise. |
| 2TA-Only | The field is optionally present, Need N in the BWP- |
| | UplinkCommon if additionalPCI-ToAddModList is |
| | present in spCellConfigDedicated or |
| | sCellConfigDedicated and it has the same number of |
| | entries as the additionalPCI-ToAddModList. It is absent |
| | otherwise. |

- RACH-ConfigCommon
The IE RACH-ConfigCommon is used to specify the cell specific random-access
parameters.

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |
| OPTIONAL, -- Need S | |
| ssb-perRACH-OccasionAndCB-PreamblesPerSSB | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},
two
ENUMERATED {n4,n8,n12,n16,n20,n24,n28,n32},

| | |
|---|---|
| four | INTEGER |
| (1..16), | |
| eight | INTEGER (1..8), |
| sixteen | INTEGER (1..4) |
| } | |
| OPTIONAL, Need M | |
| groupBconfigured | SEQUENCE{ |
| ra-Msg3SizeGroupA | ENUMERATED {b56, |
| b144, b208, b256, b282, b480, b640, | b800, |

b1000, b72, spare6, spares,spare4, spare3, spare2, spare1},

| | |
|---|---|
| messagePowerOffsetGroupB | ENUMERATED |

{ minusinfinity, dB0, dB5, dB8, dB10, dB12, dB15, dB18},

| | |
|---|---|
| numberOfRA-PreamblesGroupA | INTEGER (1..64) |
| OPTIONAL, -- Need R | |
| } | |
| ra-ContentionResolutionTimer | ENUMERATED { sf8, sf16, |
| sf24, sf32, sf40, sf48, sf56, sf64}, | |
| rsrp-ThresholdSSB | RSRP-Range |
| OPTIONAL, Need R | |
| rsrp-ThresholdSSB-SUL | RSRP-Range |
| OPTIONAL, -- Cond SUL | |
| prach-RootSequenceIndex | CHOICE { |
| I839 | INTEGER (0..837), |
| I139 | INTEGER (0..137) |
| }, | |
| msg1-SubcarrierSpacing | SubcarrierSpacing |
| OPTIONAL, -- Cond L139 | |
| restrictedSetConfig | ENUMERATED |

{unrestrictedSet, restrictedSetTypeA, restrictedSetTypeB},

| | |
|---|---|
| msg3-transformPrecoder | ENUMERATED |
| {enabled} | OPTIONAL, |
| -- Need R | |
| ..., | |
| [[ | |
| ra-PrioritizationForAccessIdentity-r16 | SEQUENCE { |
| ra-Prioritization-r16 | RA-Prioritization, |
| ra-PrioritizationForAI-r16 | BIT STRING (SIZE (2)) |
| } | |
| OPTIONAL, -- Cond InitialBWP-Only | |
| prach-RootSequenceIndex-r16 | CHOICE { |
| I571 | INTEGER (0..569), |
| I1151 | INTEGER (0..1149) |
| } OPTIONAL & Need R | |
| ]], | |
| [[ | |
| ra-PrioritizationForSlicing-r17 | RA-Prioritization ForSlicing- |
| r17 OPTIONAL, | -- Cond InitialBWP-Only |
| featureCombinationPreamblesList-r17 | SEQUENCE |

(SIZE(1..maxFeatureCombPreamblesPerRACHResource-r17)) OF
FeatureCombinationPreambles-r17 OPTIONAL -- Cond AdditionalRACH

]]
}

-- TAG-RACH-CONFIGCOMMON-STOP
featureCombinationPreambles List
Specifies a series of preamble partitions each associated to a combination of
features and 4-step RA. The network does not configure this list to have more
than 32 entries.
messagePowerOffsetGroupB
Threshold for preamble selection. Value is in dB. Value minusinfinity
corresponds to -infinity. Value dB0 corresponds to 0 dB, dB5 corresponds to 5
dB and so on (see TS 38.321 [3], clause 5.1.2). This field is set to the same value
for different repetition numbers associated with a specific FeatureCombination.
msg1-SubcarrierSpacing
Subcarrier spacing of PRACH (see TS 38.211 [16], clause 5.3.2).
Only the following values are applicable depending on the used frequency:
FRI: 15 or 30 kHz
FR2-1: 60 or 120 kHz
FR2-2: 120, 480, or 960 kHz
If absent, the UE applies the SCS as derived from the prach-ConfigurationIndex
in RACH-ConfigGeneric (see tables Table 6.3.3.1-1, Table 6.3.3.1-2, Table
6.3.3.2-2 and Table 6.3.3.2-3, TS 38.211 [16]). The value also applies to
contention free random access (RACH-ConfigDedicated), to SI-request and to
contention-based beam failure recovery (CB-BFR). But it does not apply for
contention free beam failure recovery (CF-BFR) (see
BeamFailureRecoveryConfig).
msg3-transformPrecoder
Enables the transform precoder for Msg3 transmission according to clause
6.1.3 of TS 38.214 [19]. If the field is absent, the UE disables the transformer
precoder (see TS 38.213 [13], clause 8.3).
numberOfRA-PreamblesGroupA
The number of CB preambles per SSB in group A. This determines implicitly
the number of CB preambles per SSB available in group B. (see TS 38.321
[3], clause 5.1.1). The setting should be consistent with the setting of ssb-
perRACH-Occasion AndCB-PreamblesPerSSB.
prach-RootSequenceIndex
PRACH root sequence index (see TS 38.211 [16], clause 6.3.3.1). The value
range depends on whether L=839 or L=139 or L=571 or L=1151. The length
of the root sequence corresponding with the index indicated in this IE should
be consistent with the one indicated in prach-ConfigurationIndex in the
RACH-ConfigDedicated (if configured). If prach-RootSequenceIndex-r 16 is
signalled, UE shall ignore the prach-RootSequenceIndex (without suffix).
For FR2-2, only the following values are applicable depending on the used
subcarrier spacing:
120 kHz: L=139, L=571, and L=1151
480 KHz: L=139, and L=571
960 KHz: L=139
ra-ContentionResolution Timer
The initial value for the contention resolution timer (see TS 38.321 [3], clause
5.1.5). Value s/8 corresponds to 8 subframes, value s/16 corresponds to 16
subframes, and so on.
ra-Msg3SizeGroupA
Transport Blocks size threshold in bits below which the UE shall use a
contention-based RA preamble of group A (see TS 38.321 [3], clause 5.1.2).
This field is set to the same value for different repetition numbers associated
with a specific FeatureCombination.
ra-Prioritization
Parameters which apply for prioritized random access procedure on any UL
BWP of SpCell for specific Access Identities (see TS 38.321 [3], clause
5.1.1a).
ra-PrioritizationForAI
Indicates whether the field ra-Prioritization-r 16 applies for Access Identities.
The first/leftmost bit corresponds to Access Identity 1, the next bit
corresponds to Access Identity 2. Value I indicates that the field ra-
Prioritization-r 16 applies otherwise the field does not apply (see TS 23.501
[32]).
ra-Prioritization ForSlicing
Parameters which apply to configure prioritized CBRA 4-step random access
type for slicing.
rach-ConfigGeneric
RACH parameters for both regular random access and beam failure recovery.
restrictedSetConfig
Configuration of an unrestricted set or one of two types of restricted sets, see
TS 38.211 [16], clause 6.3.3.1.
rsrp-ThresholdSSB
UE may select the SS block and corresponding PRACH resource for path-loss
estimation and (re)transmission based on SS blocks that satisfy the threshold
(see TS 38.213 [13]).
rsrp-ThresholdSSB-SUL
The UE selects SUL carrier to perform random access based on this threshold
(see TS 38.321 [3], clause 5.1.1). The value applies to all the BWPs and all
RACH configurations.
ssb-perRACH-OccasionAndCB-PreamblesPerSSB
The meaning of this field is twofold: the CHOICE conveys the information
about the number of SSBs per RACH occasion. Value oneEighth corresponds
to one SSB associated with 8 RACH occasions, value oneFourth corresponds
to one SSB associated with 4 RACH occasions, and so on. The
ENUMERATED part indicates the number of Contention Based preambles
per SSB. Value n4 corresponds to 4 Contention Based preambles per SSB,
value n8 corresponds to 8 Contention Based preambles per SSB, and so on.
The total number of CB preambles in a RACH occasion is given by CB-
preambles-per-SSB * max(1, SSB-per-rach-occasion). See TS 38.213 [13]
totalNumberOfRA-Preambles
Total number of preambles used for contention based and contention free 4-
step or 2-step random access in the RACH resources defined in RACH-
ConfigCommon, excluding preambles used for other purposes (e.g. for SI
request). If the field is absent, all 64 preambles are available for RA. The
setting should be consistent with the setting of ssb-perRACH-
OccasionAndCB-PreamblesPerSSB, i.e. it should be a multiple of the number
of SSBs per RACH occasion.

| Conditional | |
|---|---|
| Presence | Explanation |
| AdditionalRACH | The field is mandatory present if the RACH- |
| | ConfigCommon is included in an AdditionalRACH- |
| | Config. When included in initialUplinkBWP-RedCap to |
| | indicate other feature(s) than redcap and eRedCap, this |
| | field is mandatory present with at least |
| | FeatureCombinationPreambles list entries: the list |
| | entry/entries indicating only redcap or eRedCap and |
| | the other(s) indicating both redcap or eRedCap and one |
| | or multiple other feature(s) (e.g., smallData, nsag or |
| | msg3-Repetitions). |
| | Otherwise, it is optional, Need R. |
| InitialBWP-Only | This field is optionally present, Need R, if this BWP is |
| | the initial BWP of SpCell. Otherwise, the field is |
| | absent. |
| L139 | The field is mandatory present if prach- |
| | RootSequenceIndex L=139, otherwise the field is |
| | absent, Need S. |
| SUL | The field is mandatory present in rach-ConfigCommon |
| | in initialUplinkBWP if supplementaryUplink is |
| | configured in ServingCellConfigCommonSIB or if |
| | supplementaryUplinkConfig is configured in |
| | ServingCellConfigCommon; otherwise, the field is |
| | absent. This field is not configured in additionalRACH- |
| | Config. |

Meanwhile, it is considered that repeated transmission of the PRACH preamble is introduced for UL coverage enhancement of an existing NR system. Therefore, in order to support PRACH repetition, it is necessary to define how to configure the PRACH resource. Accordingly, when the PRACH repetition is introduced into an NR system, a RACH resource partitioning method therefor and a UE/base station operation related thereto are proposed in the present disclosure.

Hereinafter, a resource allocation (RACH partitioning) method for the PRACH repetition will be described.

### Method 1

Hereinafter, a method for introducing a feature for the PRACH repetition will be specifically described.

A method for introducing the feature for the PRACH repetition into the RACH partitioning may be considered. As one method, a method for additionally introducing a new feature for PRACH preamble repetition may be considered. In other words, the new feature may be additionally introduced into a feature(s) configured by the BWP-uplinkCommon based on the SIBI. As an example, the new feature for the PRACH preamble repetition may be “msg1-Repetitions-r18” or the like, and a parameter in the SIB into which the feature is to be introduced may be “FeatureCombination-r17” (e.g., FeatureCombinations configured by the BWP-UplinkCommon based on the SIBI in FIG. 4). As an example and as shown in Table 8 below, “msg1-Repetitions-r18” may be introduced instead of an existing spare parameter (e.g., “spare 4”).

TABLE 8

| FeatureCombination-r17 ::= SEQUENCE { | |
|---|---|
| redCap-r17 | ENUMERATED {true} |
| OPTIONAL, -- Need R | |
| smallData-r17 | ENUMERATED {true} |
| OPTIONAL, -- Need R | |
| nsag-r17 | NSAG-List-r17 |
| OPTIONAL, -- Need R | |
| msg3-Repetitions-r17 | ENUMERATED {true} |
| OPTIONAL, -- Need R | |
| msg1-Repetitions-r18 | ENUMERATED {true} |
| OPTIONAL, -- Need R | |
| spare3 | ENUMERATED {true} |
| OPTIONAL, -- Need R | |
| spare2 | ENUMERATED {true} |
| OPTIONAL, -- Need R | |
| spare1 | ENUMERATED {true} |
| OPTIONAL -- Need R | |
| } | |

As another method, it may be considered that one of the features provided in the existing SIB is selected, and configured to additionally perform a role of the feature for the PRACH preamble repetition. That is, when an existing defined feature is indicated, it may be configured to indicate a new feature at the same time as indicating application of the feature. As an example, msg3-Repetitions-r17 is provided in the parameter “FeatureCombination-r17” in the existing SIB, and the msg3-repetitions-r 17 may be configured to additionally perform a role of the feature for the PRACH preamble repetition. That is, the Rel-17 UE interprets/applies the msg3-Repetitions-r17 feature as being for Msg. 3 PUSCH repetition. The Rel-18 UE may interpret/apply the msg3-Repetitions-r17 feature as being for both the Msg. 3 PUSCH repetition and the PRACH preamble (Msg. 1) repetition.

A reason for this configuration is that, from the perspective of the UE that needs coverage enhancement for the Msg. 3 PUSCH, a probability that coverage enhancement of the Msg. 1 PRACH will also be required is higher.

### Method 2

Hereinafter, a method for configuring combinations of the feature for the PRACH repetition and other features will be specifically described.

When the feature for the PRACH repetition is defined as described above, it is necessary to predefine how the feature is configured to be combined with other features.

A case where a new feature (e.g., msg1-Repetitions-r18) for the PRACH repetition is introduced is as follows.

According to an embodiment, a feature newly introduced for the PRACH repetition may be configured/defined so as to be impossible to be combined with other features previously configured (or to be newly introduced). According to the embodiment, the base station may continuously configure/indicate a preamble index interval (or a specific RO) for only the PRACH repetition to the UE. Then, the UE may understand that preamble indices of the preamble index interval (or specific RO) are continuously used only for the PRACH repetition and perform the RACH procedure. That is, in the case of the preamble indices based on the interval, the UE may perform the RACH procedure based on the PRACH repetition.

According to an embodiment, the feature newly introduced for the PRACH repetition may be configured/defined so as to be possible to be combined with only a specific feature(s) among other features previously configured (or to be newly introduced). As an example, the specific feature may be msg3-Repetitions-r17. According to the embodiment, the base station may configure/indicate, to the UE, a preamble index interval (or specific RO) for only the PRACH repetition, or may configure/indicate, to the UE, only the preamble index interval (or specific RO) for the PRACH repetition additionally combined with only an Msg. 3 PUSCH repetition feature. As mentioned above, a UE that intends to repeatedly transmit the Msg. 3 PUSCH may also intend to repeatedly transmit the PRACH preamble, and thus such a configuration may be preferable. As an example, it may be assumed that the base station configures, to the UE, the Msg. 3 PUSCH repetition feature and the Msg. 1 PRACH repetition feature to be simultaneously combined in a specific preamble index interval (or specific RO). In the case of a UE that intends to perform the Msg. I PRACH repetition and the Msg. 3 PUSCH repetition, the UE may be configured to select one of the preamble indices corresponding to the region (the specific preamble index interval), and perform the RACH procedure.

According to an embodiment, the feature newly introduced for the PRACH repetition may be defined to be continuously configured in combination with a specific feature(s) among other features previously configured (or to be newly introduced). As an example, the specific feature may be msg3-Repetitions-r17. According to the embodiment, the base station may continuously configure/indicate, to the UE, a preamble index interval (or a specific RO) to which the PRACH repetition and the Msg. 3 PUSCH repetition are simultaneously applied. When the base station is defined to configure as such, the UE may understand that the Msg. 3 PUSCH repetition is continuously supported in a preamble index interval (or specific RO) in which the PRACH repetition is supported, and may perform the RACH procedure.

Alternatively, a case that an existing feature (e.g., msg3-Repetitions-r17) is configured for the PRACH repetition to also serve as the feature for the PRACH preamble repetition is considered, as follows. As an example, the feature may be configured/defined to be impossible to be combined with other features previously configured (or to be newly introduced). According to the embodiment, the base station may continuously define a preamble index interval (or a specific RO) in which only the PRACH repetition and the Msg. 3 PUSCH repetition are simultaneously supported. Then, the UE may understand that the preamble indices of the preamble index interval (or specific RO) are continuously used only for the PRACH repetition and the Msg.3 PUSCH repetition, and perform the RACH procedure.

### Method 3

Hereinafter, a method for configuring an independent RACH occasion for the PRACH repetition will be specifically described.

A method for allocating an RACH resource(s) only for the PRACH repetition through a new RACH configuration (e.g., an independent RACH configuration from an existing RACH configuration) distinguished from the existing RACH configuration may be considered. That is, the base station may provide, to the UE, one or more AdditionalRACH-Config-r17s. The base station may configure all preamble indices corresponding to ROs indicated by the RACH-ConfigCommon configured in each AdditionalRACH-Config-r17 to be used only for the RACH repetition.

As an example, it may be assumed that an SSB-to-RO mapping value is configured so that one RO may be used per one SSB beam direction. FeatureCombinationPreambles are configured based on the RACH-ConfigCommon configured in each AdditionalRACH-Config-r17. A starting preamble index and a number of preambles based on parameters within the FeatureCombinationPreambles may be configured as follows. The starting preamble index may be configured to 1 (e.g., in the case of all preamble indices 1 to 64, startPreambleForThisPartition is configured to 1, and in the case of all preamble indices 0 to 63, startPreambleForThisPartition is configured to 0). The number of preambles may be configured to 64 (e.g., numberOfPreamblesPerSSB-ForThisPartition is configured to 64).

In addition, the base station may be configured/defined to set parameters for other features in FeatureCombination-r17 to false, and to indicate only the parameters for the PRACH repetition (e.g., msg1-Repetitions-r18 or msg3-Repetitions-r17 (when reused)) to true. In this way, all preamble indices of the RO configured through the AdditionalRACH-Config-r17 may be used for the PRACH repetition. Therefore, problems that may occur when a UE performing the PRACH repetition shares an RO with UEs that do not perform the PRACH repetition (e.g., ambiguity in the operation of the base station/UE, and distinction/configuration between preambles to which the PRACH repetition is applied and preambles to which the PRACH repetition is applied is not applied within the same RO) may be prevented.

The above proposal is a method in which a specific RO is continuously used as RACH resource partitioning (i.e., a region divided by consecutive preamble indices) only for one feature for PRACH repetition transmission. In the present disclosure, ‘RACH resource partitioning’ or ‘partition’ may be interpreted/replaced as a preamble(s) based on FeatureCombinationPreambles. An additional method may be considered, which may independently configure a specific RO for the PRACH repetition transmission (so as to be distinguished from an RO for PRACH single transmission). Hereinafter, this will be specifically described.

According to an embodiment, when one or more RACH resource partitionings in a specific RO are configured/indicated, the feature for the PRACH repetition transmission may be configured/defined to be continuously included in all the RACH resource partitions allocated in the RO. In this case, for the RO, the UE may expect that only the RACH resource partitioning configured with only the feature for the PRACH repetition transmission and/or only the RACH resources partitionings configured with a combination of the feature for the PRACH repetition transmission and other features are allocated.

With this configuration, not only a UE only for the PRACH repetition transmission, but also UEs that intend to use a different feature with the PRACH repetition transmission may select the RO and perform the RACH procedure while performing the PRACH repetition transmission. That is, a UE that intends to perform the RACH procedure by using the PRACH single transmission does not select the RO. As an example, the UE that uses the PRACH single transmission may include i) a UE that does not have a PRACH repetition capability, and ii) a UE that does not intend to perform the PRACH repetition even if the UE has the PRACH repetition transmission capability.

Meanwhile, a parameter (e.g., msg1RepetitionNumber-r18) representing a number of PRACH repetition transmissions may be additionally configured/indicated to rach-ConfigCommon of legacy PRACH configuration or rach-ConfigCommon of AdditionalRACH-Config-r17.

As an example, the FeatureCombinationPreambles parameter in the rach-ConfigCommon may include a parameter/information representing the number of PRACH repetition transmissions.

As an example, the parameter representing the number of PRACH repetition transmissions may be configured/defined to indicate only one value per rach-ConfigCommon. Different rach-ConFigCommons may be configured/indicated to continuously have different values of the parameter representing the number of PRACH repetition transmissions. The UE may also expect such a configuration/indication operation. In addition, in a case that the parameter representing the number of PRACH repetition transmissions is not present (or in a case that the parameter representing the number of PRACH repetition transmissions is indicated as 1), the UE may operate by interpreting that the RACH resource is a resource for the PRACH single transmission.

Additionally, the UE may expect that the number of rach-ConfigCommons including the number of PRACH repetition transmission will be indicated in association with a repetition transmission threshold number which the base station pre-configures through the higher layer signaling. That is, if a total threshold is configured/indicated as 3, and there are 4 repetition intervals (e.g., a repetition transmission factor for each interval is configured as 1, 2, 4, or 8), the UE may expect the number of rache-Configcommons including the parameter representing the number of PRACH repetition transmissions (configured as a value other than 1) to be 3 in total. When the repetition transmission factor is 1, the UE may operate as follows. The UE may perform the PRACH single transmission based on a RACH resource of rach-configCommon not including the parameter representing the number of repetition transmissions (or an RACH resource of rach-ConfigCommon, indicating that the parameter representing the number of repetition transmissions is 1).

Alternatively, it may be assumed that different rach-ConfigCommons are indicated with a same parameter value representing the number of PRACH repetition transmissions. In this case, the UE may be configured to operate as follows. As an example, the UE may perform the PRACH repetition transmission by using rach-ConfigCommon randomly selected in an MAC layer among the plurality of rach-ConfigCommons. As an example, the UE may consider the configurations to be invalid, and perform the RACH procedure by using different rach-ConfigCommon.

It may be assumed that the RO for the PRACH repetition transmission is continuously configured independently from the RO for the PRACH single transmission. In such a case, a following operation/configuration may be applied. A parameter (e.g., msg1RepetitionNumber) representing the number of repetition transmissions may be additionally provided (configured/indicated as a value other than 1) only to the rach-ConfigCommon of the AdditionalRACH-Config-r17.

Additionally, when the parameter representing the number of repetition transmissions is included in the rach-ConfigCommon of the AdditionalRACH-Config-r17 (that is, when the UE receives the AdditionalRACH-Config-r17 including the parameter), the UE may expect that the RACH resource partitioning will be configured as in the above proposed methods (the method in which the specific RO is configured as the RO for the PRACH repetition transmission).

### Method 4

Hereinafter, base station and UE operations for configuring/indicating a preamble index interval in which a specific feature (combination) is defined will be specifically described.

When the specific feature (combination) is defined in the specific preamble index interval (or specific RO) as described above, the UE may operate as follows.

The UE may perform the RACH procedure based on one of the preamble indices related to the PRACH repetition by considering i) and ii) below.
i) a feature configured/indicated to the UE (e.g., PRACH repetition feature, Msg. 3 PUSCH repetition feature, etc.)
ii) a condition related to the operation corresponding to the configured/indicated feature (e.g., whether the RSRP value is smaller than or equal to a predefined/configured RSRP threshold)

The RSRP threshold may be configured by the parameter based on the above-described embodiments (e.g., rsrp-ThresholdMsg1-RepetitionNum2, rsrp-ThresholdMsg1-RepetitionNum4, or rsrp-ThresholdMsg1-RepetitionNum8 of the BWP-UplinkCommon).

The base station may receive the preamble index transmitted by the UE, and may determine to which interval the preamble index corresponds. Based on this, the base station may determine which feature the UE intends to request/perform, and may configure/indicate a RAR UL grant value appropriate for the feature to the UE.

The proposed method may be configured/applied to another UL signal/channel such as MSG3 PUSCH, MSGA Preamble/PUSCH, and/or PUSCH/PUCCH. Characteristically, the proposed UE/base station operation for the PRACH repetition may also be configured/applicable to UE/base station operations for repeated transmission of Msg. 4 HARQ ACK PUCCH. As an example, a feature for PUCCH repetition (e.g., pucch-Repetitions-r18) may be newly introduced into the SIB (instead of a spare parameter), or one of the existing features (e.g., msg3-Repetitions-r17) may be reused as a feature for the PUCCH repetition. Further, the feature for the PUCCH repetition may be configured to be combined only between specific features (e. g., msg3-Repetitions-r17). Alternatively, the feature for the PUCCH repetition may be configured to be defined to be continuously configured at the same time as a specific feature(s) (e.g., msg3-Repetitions-r17).

Furthermore, when the UE/base station operations for the PRACH repetition and/or the PUCCH repetition are supported simultaneously, the proposed methods may be configured/indicated/defined to be applied to both channels. As an example, both the feature for the PUCCH repetition and the feature for the PRACH repetition may be newly introduced into the SIB. One (e.g., msg3-Repetitions-r17) of the existing features may be reused as the feature for the PUCCH repetition, and/or the PRACH repetition.

Further, it is obvious that since the examples of the proposed method described above may also be included as one of implementing methods of the present disclosure, the examples may be regarded as a kind of proposed methods. Further, the proposed schemes described above may be independently implemented, but implemented in combination (or merge) of some of the proposed schemes. A rule is defined so that the base station notifies, to the UE, information regarding whether to apply the proposed methods (or information on rules of the proposed methods) through a signal (e.g., a physical layer signal or a higher layer signal) defined in advance. A higher layer may include, for example, one or more of functional layers such as MAC, RLC, RRC, and SDAP.

The methods, embodiments or descriptions for implementing the method proposed in the present disclosure may be applied separately, or one or more methods (or embodiments or descriptions) may be applied in combination.

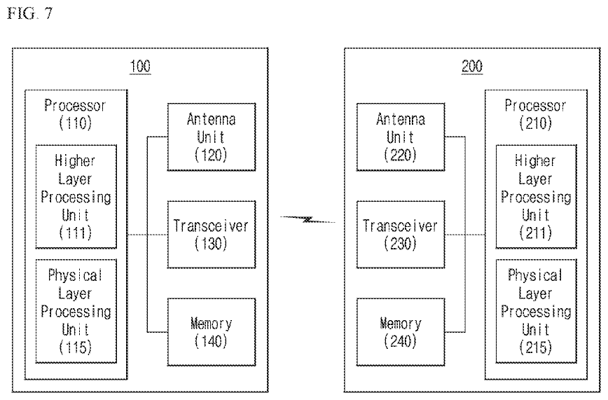

In terms of implementation, the operations (e.g., operations based on at least one of Methods 1 to 4) of the base station/terminal according to the above-described embodiments may be processed by devices (e.g., processors 110 and 210 in FIG. 7) in FIG. 7 to be described below.

Further, the operations (e.g., operations based on at least one of Methods 1 to 4) of the base station/UE according to the above-described embodiment may be stored in memories (e.g., 140 and 240 in FIG. 7) in the form of an instruction/program (e.g., instruction or executable code) for driving at least one processor (e.g., 110 and 210 in FIG. 7).

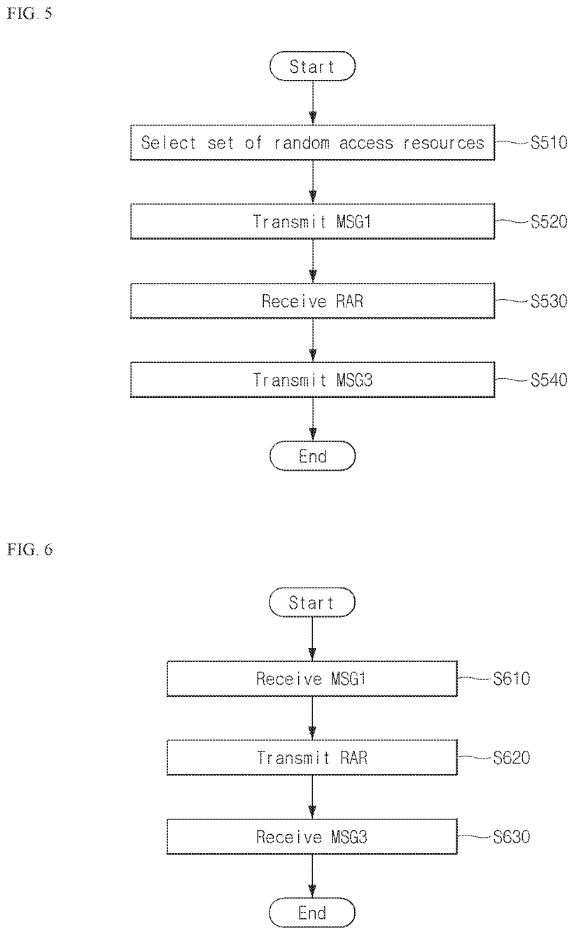

Hereinafter, the above-described embodiments will be described in detail with reference to FIGS. 5 and 6 in terms of the operations of the UE and the base station. Methods to be described are just distinguished for convenience and it is needless to say that some components of any one method may be substituted with some components of another method or may be applied in combination with each other.

FIG. 5 is a flowchart for describing a method performed by a user equipment (UE) according to one embodiment of the present disclosure.

Referring to FIG. 5, a method performed by a UE according to an embodiment of the present disclosure includes a step of selecting a set of random access resources (S510), an MSG1 transmitting step (S520), an RAR receiving step (S530), and an MSG3 transmitting step (S540).

In S510, the UE selects a set of random access resources based on initiation of a random access procedure. Parameters for the random access procedure are initialized based on a configuration for the set of the random access resources. The configuration for the set the random access resources may refer to pre-configured parameters (e.g., parameters configured based on a SIB described below).

The random access procedure may be based on a Type-1 random access procedure or a Type-2 random access procedure.

The initialization may mean that a specific parameter(s) among the pre-configured parameters (e.g., the parameters configured based on the SIB, and the parameters based on at least one of Tables 1 to 4, 6 to 8 and/or FIG. 4) is (are) determined. As an example, parameters for the random access procedure may be determined based on the set of the random access resources selected by the UE among the pre-configured parameters.

The parameters for the random access procedure may include parameters based on at least one of the above-described embodiments (e.g., at least one of Tables 1 to 4, Tables 6 to 8, and/or FIG. 4).

According to an embodiment, the parameters for the random access procedure may include a FeatureCombination parameter. The FeatureCombmination parameter may indicate one or more features.

Based on the FeatureCombination parameter, a first feature and a second feature related to the first feature may be jointly indicated. The embodiment may be based on at least one of Method 1 to Method 4. The first feature may include a repetition of the MSG1. The second feature may include a repetition of the MSG3.

The method may further include an SIB receiving step before S510. Specifically, in the SIB receiving step, the UE receives System Information Block (SIB) (e.g., SIBI) from the base station. A BWP-uplinkCommon parameter may be configured based on the SIB. A plurality of FeatureCombination parameters may be configured based on the BWP-uplinkCommon parameter. The FeatureCombination parameter initialized/determined for the random access procedure may be one of the plurality of FeatureCombination parameters.

The BWP-uplinkCommon parameter may include i) a rach-ConfigCommon parameter and ii) one or more AdditionalRACH-Config parameters.

In S520, the UE transmits MSG1 to the base station. The transmission of the MSG1 may mean transmission of a Physical Random Access Channel (PRACH). As an example, the repetition of the MSG1 may mean a repetition of the PRACH/RACH/Random access preamble in the above-described embodiments. Specifically, the MSG1 may be transmitted based on Table 1. When the random access procedure is the Type-2 random access procedure, the MSG 1 may be interpreted/replaced as MSGA in the following description.

As an example, based on the repetition of the MSG1 being indicated by the FeatureCombination parameter, the MSG1 may be repeatedly transmitted.

As an example, the MSG1 may be transmitted based on one or more preambles. As a specific example, the one or more preambles may be based on one Physical Random Access Channel occasion (RO). The MSG1 being repeatedly transmitted may mean that MSG1 (PRACH) transmission based on one RO is performed a plurality of times. Therefore, the repeated transmission of the MSG1 may mean PRACH transmission based on a plurality of ROs. In this case, the plurality of ROs may be associated with a same Synchronization Signal/Physical Broadcast CHannel Block index (SS/PBCH Block index).

The one or more preambles may be determined based on a FeatureCombinationPreambles parameter. More specifically, based on a startPreambleForThisPartition parameter and a numberOfPreambleSerSSB-ForThisPartition parameter in the FeatureCombminationPreambles parameter, the one or more preambles may be determined/defined.

A first preamble related to the set of the random access resources may be defined based on the startPreambleForThisPartition parameter. Consecutive preambles may be defined for the one or more features mapped to each Synchronization Signal/Physical BroadCast CHannel Block (SSB) based on the numberOfPreamblesPerSSB-ForThisPartition parameter.

According to an embodiment, the FeatureCombinationPreambles parameter may be configured based on i) one of the one or more AdditionalRACH-Config parameters or ii) the rach-ConfigCommon parameter. Hereinafter, this will be specifically described with reference to FIG. 4. The rach-ConFigCommon parameter included in each of the one or more AdditionalRACH-config parameters includes one or more FeatureCombminationPreambles parameters. The rach-ConfigCommon parameter included in the BWP-uplinkCommon parameter includes one or more FeatureCombminationPreambles parameters. Each FeatureCombigationPreamble parameter may include one FeatureCombution parameter.

The FeatureCombinationPreambles parameter (for the random access procedure) may include the FeatureCombmination parameter.

The one or more preambles may be based on consecutive preambles for the one or more features. The number of consecutive preambles may be 64. The consecutive preambles may be defined by the above-described numberOfPreamblesPerSSB-ForThisPartition parameter.

One Synchronization Signal/Physical Broadcast CHannel Block (SSB) may be mapped to a Physical Random Access Channel (PRACH) Occasion related to the consecutive preambles.

According to an embodiment, the FeatureCombinationPreambles parameter may include information for a repetition number of the MSG1. As an example, an msg1-RepetitionNum-r18 may be configured as n2, n4, or n8.

According to an embodiment, a specific AdditionalRACH-Config parameter among the one or more AdditionalRACH-Config parameters may be related to the first feature (e.g., MSG1 repetitions) The FeatureCombinationPreambles parameter (including the FeatureCombmination parameter for the random access procedure) may be one of one or more FeatureCombigationPreambles parameters based on the specific AdditionalRACH-Config parameter.

According to an embodiment, the BWP-uplinkCommon parameter includes information representing an RSRP threshold related to the repetition of the MSG1. The repetition of the MSG1 may be performed based on a Reference Signal Received Power (RSRP) measured by the UE being smaller than the RSRP threshold. As an example, the RSRP threshold may include one or more RSRP thresholds. The one or more RSRP thresholds may include an RSRP threshold for each repetition number (e.g., an RSRP threshold for a repetition number of 2, 4, or 8). The one or more RSRP thresholds may include i) rsrp-ThresholdMsg1-RepetitionNum2, ii) rsrp-ThresholdMsg1-RepetitionNum4, and/or iii) rsrp-ThresholdMsg1-RepetitionNum8 in the BWP-UplinkCommon in Table 7.

In S530, the UE receives a Random Access Response (RAR) from the base station. The RAR may be based on MSG2 of the Type-1 random access procedure or MSGB of the Type-2 random access procedure.

In S540, the UE transmits MSG3 to the base station. When the random access procedure is the Type-2 random access procedure, this step may be omitted.

Based on a feature related to the repetition of the MSG3 being indicated by the FeatureCombination parameter, the MSG3 may be repeatedly transmitted.

As an example, the transmission of the MSG3 may mean transmission of a Physical Uplink Shared Channel (PUSCH) scheduled by an uplink grant (UL grant) related to the RAR.

The operations based on S510 to S540 and the SIB receiving step described above may be implemented by devices in FIG. 7. For example, a UE 200 may control one or more transceivers 230 and/or one or more memories 240 to perform the operations based on S510 to S540 and the SIB receiving step.

Hereinafter, the embodiments described above will be specifically described in terms of the operations of the base station.

S610 to S630, and an SIB transmitting step described below correspond to S510 to S540, and the SIB receiving step described in FIG. 5. By considering the correspondence relationship, redundant descriptions are omitted. That is, a specific description of base station operations described below may be replaced with the description/embodiment of FIG. 5 corresponding to the corresponding operation. As an example, the description/embodiments of S510 to S540 of FIG. 5 may be additionally applied to the base station operations of S610 to S630 described below. As an example, the description/embodiment of the UE operation in the SIB receiving step may be additionally applied to the base station operation in the SIB transmitting step described below.

FIG. 6 is a flowchart for describing a method performed by a base station according to another embodiment of the present disclosure.

Referring to FIG. 6, a method performed by a base station according to another embodiment of the present disclosure includes an MSG1 receiving step (S610), an RAR transmitting step (S620), and an MSG3 receiving step (S630).

In S610, the base station receives MSG1 from the UE based on initiation of a Random Access procedure. Parameters for the Random Access procedure is initialized based on a configuration for a set of Random Access resources.

The parameters for the Random Access procedure may include a FeatureCombination parameter. The FeatureCombmination parameter may indicate one or more features. Based on the FeatureCombination parameter, a first feature and a second feature related to the first feature may be jointly indicated.

The first feature may include a repetition of the MSG1. The second feature may include a repetition of the MSG3.

The method may further include an SIB transmitting step before S610. Specifically, in the SIB transmitting step, the base station transmits a System Information Block (SIB) (e.g., SIBI) to the UE.

In S620, the base station transmits a Random Access Response (RAR) to the UE.

In S630, the base station receives MSG3 from the UE.

The operations based on S610 to S630 and the SIB transmitting step described above may be implemented by the devices in FIG. 7. For example, a base station 100 may control one or more transceivers 130 and/or one or more memories 140 to perform the operations based on steps S610 to S630 and the SIB transmitting step.

A device to which an embodiment of the present disclosure is applicable (a device implementing the method/operation according to an embodiment of the present disclosure) is described below with reference to FIG. 7.

FIG. 7 illustrates configuration of a first device and a second device according to an embodiment of the present disclosure.

A first device 100 may include a processor 110, an antenna unit 120, a transceiver 130, and a memory 140.

The processor 110 may perform baseband-related signal processing and include a higher layer processing unit 111 and a physical layer processing unit 115. The higher layer processing unit 111 may process operations of the MAC layer, the RRC layer, or higher layers. The physical layer processing unit 115 may process the operation of the PHY layer. For example, if the first device 100 is a base station (BS) device in BS-UE communication, the physical layer processing unit 115 may perform uplink reception signal processing, downlink transmission signal processing, and the like. For example, if the first device 100 is a first UE device in inter-UE communication, the physical layer processing unit 115 may performs downlink reception signal processing, uplink transmission signal processing, sidelink transmission signal processing, and the like. The processor 110 may control the overall operation of the first device 100 in addition to performing the baseband-related signal processing.

The antenna unit 120 may include one or more physical antennas and support MIMO transmission/reception if the antenna unit 120 includes a plurality of antennas. The transceiver 130 may include a radio frequency (RF) transmitter and an RF receiver. The memory 140 may store information processed by the processor 110 and software, operating systems, and applications related to the operation of the first device 100. The memory 140 may also include components such as a buffer.

The processor 110 of the first device 100 may be configured to implement the operation of the BS in the BS-UE communication (or the operation of the first UE device in the inter-UE communication) in embodiments described in the present disclosure.

The second device 200 may include a processor 210, an antenna unit 220, a transceiver 230, and a memory 240.

The processor 210 may perform baseband-related signal processing and include a higher layer processing unit 211 and a physical layer processing unit 215. The higher layer processing unit 211 may process the operation of the MAC layer, the RRC layer, or higher layers. The physical layer processing unit 215 may process the operation of the PHY layer. For example, if the second device 200 is a UE device in BS-UE communication, the physical layer processing unit 215 may perform downlink reception signal processing, uplink transmission signal processing, and the like. For example, if the second device 200 is a second UE device in inter-UE communication, the physical layer processing unit 215 may perform downlink reception signal processing, uplink transmission signal processing, sidelink reception signal processing, and the like. The processor 210 may control the overall operation of the second device 210 in addition to performing the baseband-related signal processing.

The antenna unit 220 may include one or more physical antennas and support MIMO transmission/reception if the antenna unit 220 includes a plurality of antennas. The transceiver 230 may include an RF transmitter and an RF receiver. The memory 240 may store information processed by the processor 210 and software, operating systems, and applications related to the operation of the second device 200. The memory 240 may also include components such as a buffer.

The processor 210 of the second device 200 may be configured to implement the operation of the UE in the BS-UE communication (or the operation of the second UE device in the inter-UE communication) in embodiments described in the present disclosure.

The descriptions for the BS and the UE in the BS-UE communication (or the first UE device and the second UE device in the inter-UE communication) in the examples of the present disclosure can be equally applied to the operations of the first device 100 and the second device 200, and redundant descriptions are omitted.

The wireless communication technology implemented in the devices 100 and 200 according to the present disclosure may further include narrowband Internet of Things (NB-IoT) for low-power communication in addition to LTE, NR, and 6G. For example, the NB-IoT technology may be an example of a low power wide area network (LPWAN) technology and may be implemented in standards such as LTE Cat NB1 and/or LTE Cat NB2. The NB-IoT technology is not limited to the above-described names.

Additionally or alternatively, the wireless communication technology implemented in the devices 100 and 200 according to the present disclosure may perform communication based on LTE-M technology. For example, the LTE-M technology may be an example of the LPWAN technology, and may be called by various names such as enhanced machine type communication (eMTC). For example, the LTE-M technology may be implemented with at least one of various standards such as 1) LTE CAT 0, 2) LTE Cat M1, 3) LTE Cat M2, 4) LTE non-BL (non-Bandwidth Limited), 5) LTE-MTC, 6) LTE machine type communication, and/or 7) LTE M. The LTE-M technology is not limited to the above-mentioned names.

Additionally or alternatively, the wireless communication technology implemented in the devices 100 and 200 according to the present disclosure may include at least one of ZigBee, Bluetooth, and low power wide area network (LPWAN) in consideration of low power communication, and is not limited to the above-mentioned names. For example, the ZigBee technology may create personal area networks (PAN) related to small/low-power digital communication based on various standards such as IEEE 802.15.4, and may be called by various names.

1. A method, performed by a user equipment (UE), comprising:
selecting a set of Random Access resources based on an initiation of a Random Access procedure, wherein parameters for the Random Access procedure are initialized based on a configuration for the set of the Random Access resources;
transmitting a Message 1 (MSG1);
receiving a Random Access Response (RAR); and
transmitting a Message 3 (MSG3);
wherein the parameters for the Random Access procedure include a FeatureCombination parameter,
wherein the FeatureCombination parameter indicates one or more features,
wherein, based on the FeatureCombination parameter, a first feature and a second feature related to the first feature are jointly indicated,
wherein the first feature includes a repetition of the MSG1,
wherein the second feature includes a repetition of the MSG3.

2. The method of claim 1, further comprising:
receiving System Information Block (SIB),
wherein a BWP-uplinkCommon parameter is configured based on the SIB; and
wherein a plurality of FeatureCombination parameters are configured based on the BWP-uplinkCommon parameter.

3. The method of claim 2, wherein the BWP-uplink connection parameter includes i) a rach-ConfigCommon parameter and ii) one or more AdditionalRACH-Config parameters.

4. The method of claim 3, wherein the MSG1 is transmitted based on one or more preambles, and
wherein the one or more preambles are determined based on a FeatureCombinationPreambles parameter.

5. The method of claim 4, wherein the FeatureCombinationPreambles parameter is configured based on i) one of the one or more AdditionalRACH-Config parameters or ii) the rach-ConfigCommon parameter, and
wherein the FeatureCombinationPreambles parameter includes the FeatureCombination parameter.

6. The method of claim 4, wherein the one or more preambles are based on consecutive preambles for the one or more features, and
wherein a number of the consecutive preambles is 64.

7. The method of claim 6, wherein one Synchronization Signal/Physical Broadcast CHannel Block (SSB) is mapped to a Physical Random Access Channel (PRACH) Occasion related to the consecutive preambles.

8. The method of claim 4, wherein the FeatureCombinationPreambles parameter includes information for a repetition number of the MSG1.

9. The method of claim 4, wherein a specific AdditionalRACH-Config parameter among the one or more AdditionalRACH-Config parameters is related to the first feature.

10. The method of claim 9, wherein the FeatureCombinationPreambles parameter is one of one or more FeatureCombinationPreambles parameters based on the specific AdditionalRACH-Config parameter.

11. The method of claim 3, wherein the BWP-uplinkCommon parameter includes information representing an RSRP threshold related to the repetition of the MSG1.

12. A user equipment (UE) comprising:
one or more transceivers;
one or more processors; and
one or more memories connected to the one or more processors and storing instructions, wherein the instructions configure the one or more processors to perform, based on being executed by the one or more processors, operations comprising:
selecting a set of Random Access resources based on an initiation of a Random Access procedure, wherein parameters for the Random Access procedure are initialized based on a configuration for the set of the Random Access resources;
transmitting a Message 1 (MSG1);
receiving a Random Access Response (RAR); and
transmitting a Message 3 (MSG3);
wherein the parameters for the Random Access procedure include a FeatureCombination parameter,
wherein the FeatureCombination parameter indicates one or more features,
wherein, based on the FeatureCombination parameter, a first feature and a second feature related to the first feature are jointly indicated,
wherein the first feature includes a repetition of the MSG1,
wherein the second feature includes a repetition of the MSG3.

13-15. (canceled)

16. A base station comprising:
one or more transceivers;
one or more processors; and
one or more memories connected to the one or more processors and storing instructions, wherein the instructions configure the one or more processors to perform, based on being executed by the one or more processors, operations comprising:
receiving a Message 1 (MSG1) based on an initiation of a Random Access procedure,
transmitting a Random Access Response (RAR); and
receiving a Message 3 (MSG3);
wherein parameters for the Random Access procedure are initialized based on a configuration for a set of Random Access resources;
wherein the parameters for the Random Access procedure include a FeatureCombination parameter,
wherein the FeatureCombination parameter indicates one or more features,
wherein, based on the FeatureCombination parameter, a first feature and a second feature related to the first feature are jointly indicated,
wherein the first feature includes a repetition of the MSG1,
wherein the second feature includes a repetition of the MSG3.
